(19) United States
(12) Patent Application Publication
(10) Pub. No.: US 2026/0099285 A1
(43) Pub. Date: Apr. 9, 2026

(54) NON-TRANSITORY COMPUTER-READABLE STORAGE MEDIUM STORING APPLICATION PROGRAM, INFORMATION PROCESSING APPARATUS, AND CONTROL METHOD OF INFORMATION PROCESSING APPARATUS

(71) Applicant: CANON KABUSHIKI KAISHA, Tokyo (JP)

(72) Inventor: SHIHO SEKIGUCHI, Kanagawa (JP)

(21) Appl. No.: 19/350,214

(22) Filed: Oct. 6, 2025

(30) Foreign Application Priority Data
Oct. 8, 2024 (JP) 2024-176738

(51) Int. Cl. G06F 3/12; H04W 8/00; H04W 48/20

(52) U.S. Cl. CPC G06F 3/1236; G06F 3/1205; H04W 8/005; H04W 48/20

(57) ABSTRACT

An information processing apparatus including: a display unit configured to display, in a case where a selection corresponding to connecting the communication apparatus to another apparatus by a connection method using a wireless Local Area Network is performed on a selection screen, display a confirmation screen for prompting a user to confirm whether an apparatus operating as an access point exists around the communication apparatus; and an execute unit configured to, execute processing for connecting the communication apparatus to another apparatus by the connection method in a case where an operation corresponding to confirming that an apparatus operating as an access point exists is performed on the confirmation screen, and not to execute the processing in a case where an operation corresponding to confirming that an apparatus operating as an access point does not exist is performed on the confirmation screen.

### BACKGROUND

### Field of the Technology

The present disclosure relates to a non-transitory computer-readable storage medium storing an application program, an information processing apparatus, and a control method of the information processing apparatus.

### Description of the Related Art

A technique for causing a communication apparatus such as a printer to connect to another apparatus by an information processing apparatus such as a smartphone has been known. Japanese Patent Laid-Open No. 2016-127545 describes that an information processing apparatus transmits information to a communication apparatus, thereby setting the communication apparatus in a connection mode for deciding the connection form between the information processing apparatus and the communication apparatus.

### SUMMARY

The present disclosure provides a technique that improves convenience when an information processing apparatus causes a communication apparatus to connect to another apparatus.

The present disclosure in one aspect provides a non-transitory computer-readable storage medium storing an application program configured to cause a computer of an information processing apparatus to function as: a first display unit configured to display a selection screen for selecting any connection method of connecting a communication apparatus to another apparatus; a second display unit configured to, in a case where a selection corresponding to connecting the communication apparatus to another apparatus by a first connection method using a wireless Local Area Network (LAN) is performed on the selection screen, display a confirmation screen for prompting a user to confirm whether an apparatus operating as an access point exists around the communication apparatus; and an execution unit configured to execute connection setting processing for connecting the communication apparatus to another apparatus by the first connection method in a case where an operation corresponding to confirming that an apparatus operating as an access point exists around the communication apparatus is performed on the confirmation screen, and not to execute the connection setting processing in a case where an operation corresponding to confirming that an apparatus operating as an access point does not exist around the communication apparatus is performed on the confirmation screen.

The present disclosure in another aspect provides a non-transitory computer-readable storage medium storing an application program configured to cause a computer of an information processing apparatus to function as: a first display unit configured to display a selection screen for selecting any connection method of connecting a communication apparatus to another apparatus; a determination unit configured to, in a case where a selection corresponding to connecting the communication apparatus to another apparatus by a first connection method using a wireless Local Area Network (LAN) is performed on the selection screen, determine whether an apparatus operating as an access point exists around the communication apparatus based on information concerning a network connected to the information processing apparatus; and an execution unit configured to execute connection setting processing for connecting the communication apparatus to another apparatus by the first connection method in a case where it is determined that an apparatus operating as an access point exists around the communication apparatus, and not to execute the connection setting processing in a case where it is determined that an apparatus operating as an access point does not exist around the communication apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the configuration of a communication system;

FIG. 2 is a block diagram for explaining an example of the hardware configurations;

FIG. 3 is a flowchart showing an example of the processing executed by a terminal apparatus;

FIG. 4 is a flowchart showing an example of the processing executed by the terminal apparatus;

FIG. 5 is a flowchart showing an example of the processing executed by the terminal apparatus;

FIGS. 6A to 6C are views each showing an example of a screen displayed on a display unit of the terminal apparatus;

FIG. 7 is a flowchart showing an example of the processing executed by the terminal apparatus;

FIG. 8 is a flowchart showing an example of the processing executed by a communication apparatus;

FIGS. 9A to 9C are views each showing an example of a screen displayed on the display unit of the terminal apparatus;

FIGS. 10A to 10C are views each showing an example of a screen displayed on the display unit of the terminal apparatus;

FIGS. 11A and 11B are views each showing an example of a screen displayed on the display unit of the terminal apparatus;

FIG. 12 is a view showing an example of a screen displayed on the display unit of the terminal apparatus;

FIG. 13 is a flowchart showing an example of the processing executed by a terminal apparatus;

FIG. 14 is a flowchart showing an example of the processing executed by a terminal apparatus;

FIG. 15 is a flowchart showing an example of the processing executed by the terminal apparatus;

FIGS. 16A and 16B are flowcharts showing an example of the processing executed by the terminal apparatus;

FIGS. 17A and 17B are views each showing an example of a screen displayed on a display unit of the terminal apparatus;

FIG. 18 is a flowchart showing an example of the processing executed by the terminal apparatus; and

FIG. 19 is a flowchart showing an example of the processing executed by a communication apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

As a technique for causing a communication apparatus to connect to another apparatus by an information processing apparatus becomes widespread, it is demanded that convenience when the information processing apparatus causes the communication apparatus to connect to the other apparatus be improved.

### First Embodiment

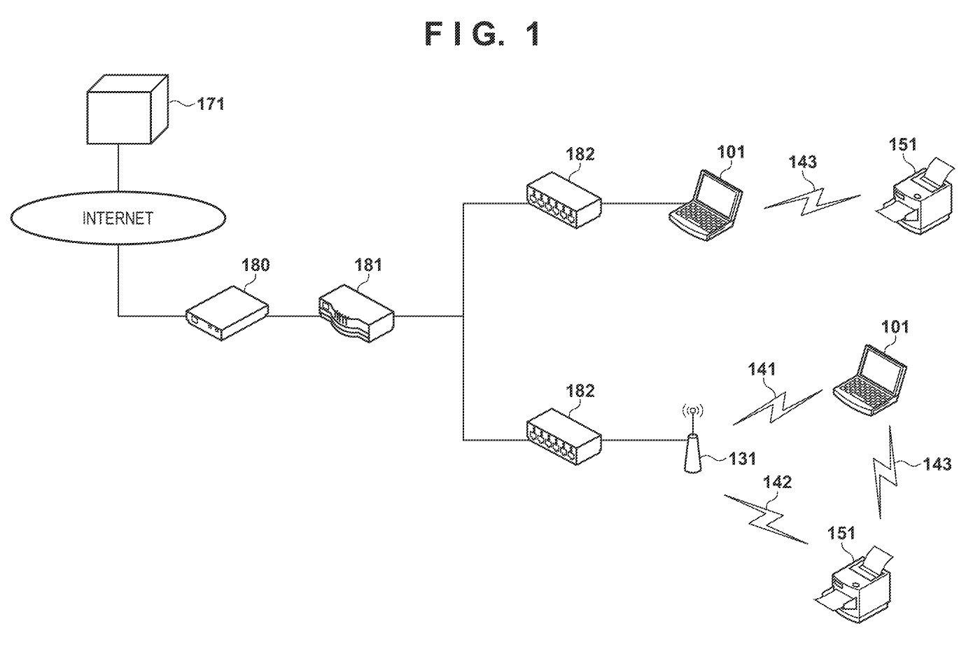

With reference to FIG. 1, the system configuration in this embodiment will be described. The communication system in this embodiment includes an information processing apparatus and a communication apparatus. As the information processing apparatus, a smartphone is exemplified in this embodiment, but the information processing apparatus is not limited thereto and various kinds of apparatuses such as a terminal apparatus, a notebook PC, a tablet terminal, a Personal Digital Assistant (PDA), and a digital camera are applicable. As the communication apparatus, a printer is exemplified in this embodiment, but the communication apparatus is not limited thereto and various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a copying machine, a facsimile apparatus, a terminal apparatus, a smartphone, a notebook PC, a tablet terminal, a PDA, a digital camera, a music playback device, a television, a smart speaker, and the like are applicable. In addition, a multi-function peripheral having a plurality of functions such as a copying function, a FAX function, and a print function is also applicable. In this embodiment, as an example, the communication apparatus is assumed to be a multi-function printer having a print function and a scanner function.

A terminal apparatus 101 is an information processing apparatus according to this embodiment. A communication apparatus 151 is a communication apparatus according to this embodiment. An access point 131 is an external apparatus that exists outside the terminal apparatus 101 and outside the communication apparatus 151. Note that the access point will be referred to as an AP in the following description. The AP 131 indicates an apparatus that operates as an AP, more specifically, for example, a device such as a wireless LAN router. Note that the AP 131 is not limited to the wireless LAN router and may be an apparatus capable of relaying wireless communication. For example, the AP 131 may be an apparatus that has an AP function for operating as an AP but does not have a router function. A Local Area Network (LAN) formed by the AP 131 includes the AP 131, the communication apparatus 151, and the terminal apparatus 101. On the other hand, a Wide Area Network (WAN) includes the AP 131 and an external server 171.

The external server 171 is a server that can provide, via the Internet, a service to an apparatus connected to the AP 131. A modem 180 is an apparatus that converts an analog signal received via the Internet into a digital signal. In accordance with the signal type, for example, when the signal is received via optical fiber connection, an Optical Network Unit is used.

A router 181 is an external apparatus that exists outside the terminal apparatus 101 and outside the communication apparatus 151. The router 181 has a function of relaying multiple terminal apparatuses 101 on networks, and assigns Internet Protocol Addresses (IP addresses) to the terminal apparatuses 101 connected to the networks to exchange packets between the networks. Network hubs 182 are external apparatuses for connecting the multiple terminal apparatuses 101 to the Internet, that is, connecting the multiple terminal apparatuses 101 to the router 181.

In this embodiment, when infrastructure connection (to be described later) is established, the terminal apparatus 101 can communicate with the communication apparatus 151 via the AP 131. Furthermore, when direct connection (to be described later) is established, the terminal apparatus 101 can directly communicate with the communication apparatus 151 without intervention of the AP 131. Note that in the following description, a connection with the AP corresponds to a connection with the network formed by the AP. Note that the AP may be capable of forming a plurality of networks at the same time. In that case, a connection with the AP may be a connection with any one of the plurality of networks formed by the AP.

In this embodiment, each of a connection 141 between the terminal apparatus 101 and the AP 131 and a connection 142 between the communication apparatus 151 and the AP 131 is a connection using a communication method based on the IEEE 802.11 series standard. More specifically, the communication method based on the IEEE 802.11 series standard is Wireless Fidelity (Wi-Fi)^{®}. A connection 143 between the terminal apparatus 101 and the communication apparatus 151 is Wi-Fi or Bluetooth^{®} Low Energy (BLE). Note that the communication method used for each connection is not limited to this form, and may be, for example, Bluetooth Classic, Wi-Fi Aware, Near Field Communication (NFC), or the like. The AP 131 and the external server 171 can communicate via the Internet. While the AP 131 is connected to the Internet, the apparatuses (the terminal apparatus 101 and the communication apparatus 151) connected to the AP 131 can also use the Internet. Note that each of the connection 141 between the terminal apparatus 101 and the AP 131 and the connection 142 between the communication apparatus 151 and the AP 131 may be a wired LAN connection.

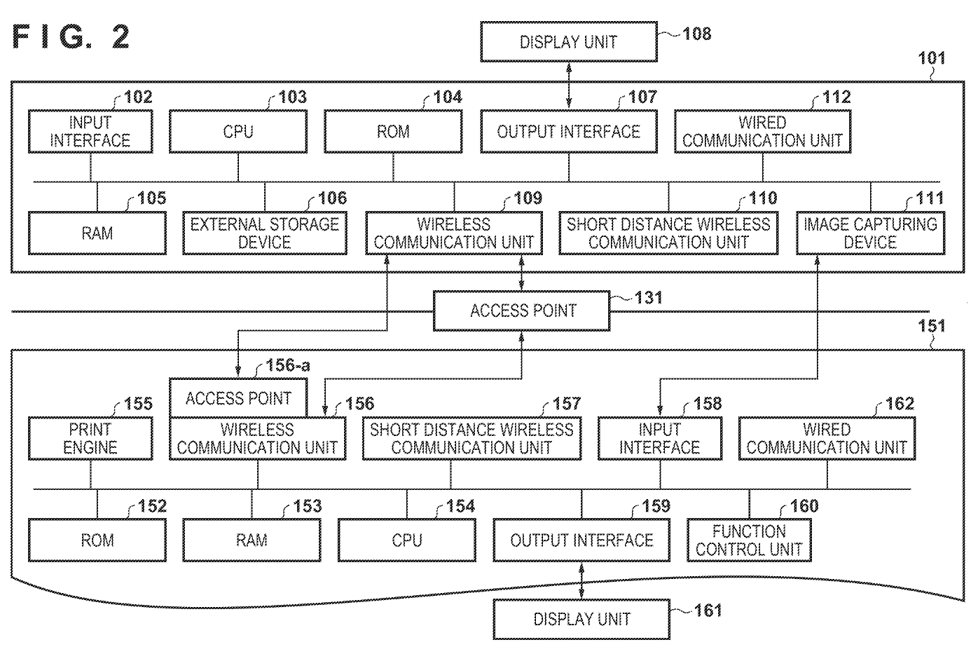

Next, the configuration of the terminal apparatus 101 according to this embodiment, and the configuration of the communication apparatus 151 that can communicate with the terminal apparatus 101 according to this embodiment will be described with reference to the block diagram of FIG. 2. The following configurations will be exemplified in this embodiment, but this embodiment is applicable to an apparatus that can communicate with the communication apparatus 151 and, in particular, functions are not limited to those shown in FIG. 2.

The terminal apparatus 101 includes an input interface 102, a CPU 103, a ROM 104, a RAM 105, an external storage device 106, an output interface 107, a display unit 108, a wireless communication unit 109, a short distance wireless communication unit 110, an image capturing device 111, a wired communication unit 112, and the like. The CPU 103, the ROM 104, the RAM 105, and the like form the computer of the terminal apparatus 101. The terminal apparatus 101 is assumed to be a device such as a smartphone, but not limited to a smartphone.

The input interface 102 is an interface for accepting a data input and an operation instruction from the user, and is formed by a physical keyboard, buttons, a touch panel, and the like. Note that the output interface 107 (to be described later) and the input interface 102 may have the same configuration, and output of a screen and acceptance of an operation from the user may be done by the same configuration.

The CPU 103 is a system control unit, and controls the overall terminal apparatus 101.

The ROM 104 stores permanent data such as control programs to be executed by the CPU 103, data tables, and an operating system (to be referred to as an OS hereinafter) program. In this embodiment, the control programs stored in the ROM 104 perform software execution control such as scheduling, task switch, and interrupt processing under the management of the embedded OS stored in the ROM 104. In this embodiment, the ROM 104 stores a setup application program (to be referred to as a setup application hereinafter). The setup application is externally installed in the terminal apparatus 101 by, for example, a store application program. The setup application is an application provided by the vender of the communication apparatus 151. Details of the setup application will be described later.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the terminal apparatus 101, management data of the terminal apparatus 101, and the like is also provided in the RAM 105. Furthermore, the RAM 105 is also used as the main memory and work memory of the CPU 103.

The external storage device 106 has various programs such as a print information generation program for generating print information interpretable by the communication apparatus 151, and an information transmission/reception control program for performing transmission/reception to/from the communication apparatus 151 connected via the wireless communication unit 109. The external storage device 106 also saves various kinds of information to be used by these programs, and image data obtained from another information processing apparatus or the Internet.

The output interface 107 is an interface that performs control for causing the display unit 108 to perform display of data and notification of the state of the terminal apparatus 101.

The display unit 108 is formed by a Light Emitting Diode (LED), a Liquid Crystal Display (LCD), or the like, and performs display of data and notification of the state of the terminal apparatus 101. Note that a software keyboard including keys such as numerical input keys, a mode setting key, an OK key, a cancel key, and a power key may be provided on the display unit 108 so that an input from the user is accepted via the display unit 108.

The wireless communication unit 109 is configured to be wirelessly connected to an apparatus such as the communication apparatus 151 or the AP 131 to execute data communication. For example, the wireless communication unit 109 may directly communicate with the communication apparatus 151 by wireless communication, or may communicate therewith via the AP 131 existing outside the terminal apparatus 101 and the communication apparatus 151. As the wireless communication method of the wireless communication unit 109, Wi-Fi, which is the communication method based on the IEEE 802.11 standard, is used in this embodiment, but Bluetooth Classic or the like may be used. In this embodiment, the wireless LAN is a Wi-Fi network. The AP 131 is, for example, a device such as a wireless LAN router. Note that in this embodiment, a method of connecting the terminal apparatus 101 and the communication apparatus 151 directly without intervention of the external AP is referred to as a direct connection method. A method of connecting the terminal apparatus 101 and the communication apparatus 151 via the external AP is referred to as an infrastructure connection method.

The short distance wireless communication unit 110 is configured to execute data communication with an apparatus such as the communication apparatus 151 by a short distance wireless communication method, and performs communication by a communication method different from that of the wireless communication unit 109. The short distance wireless communication unit 110 can be connected to a short distance wireless communication unit 157 in the communication apparatus 151. Note that examples of the communication method of the short distance wireless communication unit 110 are, BLE, Bluetooth Classic, Wi-Fi Aware, NFC, and the like.

The image capturing device 111 is a device that converts an image captured by an image sensor into digital data. The digital data is temporarily stored in the RAM 105. Then, the digital data is converted into a predetermined image format by a program executed by the CPU 103, and saved as image data in the external storage device 106.

The wired communication unit 112 is configured to be connected, via a wire, to an apparatus such as the communication apparatus 151 or the AP 131 to execute data communication. For example, the wired communication unit 112 performs communication via a wired LAN. In this embodiment, the communication in the wired LAN uses the Ethernet standard. Note that the wired communication unit 112 is not limited to this form, and may perform communication via, for example, a Universal Serial Bus (USB) cable.

The communication apparatus 151 includes a ROM 152, a RAM 153, a CPU 154, a print engine 155, a wireless communication unit 156, the short distance wireless communication unit 157, an input interface 158, an output interface 159, a function control unit 160, a display unit 161, a wired communication unit 162, and the like. The ROM 152, the RAM 153, the CPU 154, and the like form the computer of the communication apparatus 151.

The wireless communication unit 156 is configured to be wirelessly connected to an apparatus such as the terminal apparatus 101 or the AP 131 to execute data communication. As the wireless communication method of the wireless communication unit 156, Wi-Fi is used in this embodiment, but Bluetooth Classic or the like may be used. Note that the wireless communication unit 156 includes, as an internal AP of the communication apparatus 151, an AP 156-a which is used to connect to an apparatus such as the terminal apparatus 101. Note that this AP can be connected to the wireless communication unit 109 of the terminal apparatus 101. Note that the wireless communication unit 156 may directly communicate with the terminal apparatus 101 via the AP 156-a, or may communicate with the terminal apparatus 101 via the AP 131. The AP 156-a may be hardware functioning as an AP, or the wireless communication unit 156 may be operated as the AP 156-a by software for causing it to function as an AP. The internal AP of the communication apparatus 151 may be formed from a plurality of APs having different SSIDs or passwords. In this embodiment, the internal AP of the communication apparatus 151 includes at least a connection setting AP to be described later.

The RAM 153 is formed by a DRAM or the like that needs a backup power supply. Note that the RAM 153 can store important data such as program control variables without volatilization because the data are held by supplying power (not shown) for data backup. Furthermore, the RAM 153 is used as the main memory and work memory of the CPU 154, and operates as a reception buffer for temporarily saving print information received from the terminal apparatus 101 or the like to save various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151.

Based on the information saved in the RAM 153 or a print job received from the terminal apparatus 101 or the like, the print engine 155 forms an image on a print medium such as a paper sheet using a printing material such as ink and outputs the print result. At this time, the print job transmitted from the terminal apparatus 101 or the like has a large transmission data amount, and high-speed communication is required. Thus, the print engine 155 receives the print job via the wireless communication unit 156 capable of performing communication at a higher speed than the short distance wireless communication unit 157.

The short distance wireless communication unit 157 is configured to perform communication with an apparatus such as the terminal apparatus 101 by a short distance wireless communication method. Note that examples of the communication method of the short distance wireless communication unit 157 are BLE, Bluetooth Classic, Wi-Fi Aware, and the like.

The input interface 158 is an interface for accepting a data input and an operation instruction from the user, and is formed by a physical keyboard, buttons, a touch panel, and the like. Note that the output interface 159 (to be described later) and the input interface 158 may have the same configuration, and output of a screen and acceptance of an operation from the user may be done by the same configuration. The output interface 159 is an interface that performs control for causing the display unit 161 to perform display of data and notification of the state of the communication apparatus 151.

The function control unit 160 manages the function operation as to whether to simultaneously operate the functions of the communication apparatus 151.

The display unit 161 is formed by a Light Emitting Diode (LED), a Liquid Crystal Display (LCD), or the like, and performs display of data and notification of the state of the communication apparatus 151. Note that a software keyboard including keys such as numerical input keys, a mode setting key, an OK key, a cancel key, and a power key may be provided on the display unit 161 so that an input from the user is accepted via the display unit 161.

The wired communication unit 162 is configured to be connected, via a wire, to an apparatus such as the terminal apparatus 101 or the AP 131 to execute data communication. For example, the wired communication unit 162 performs communication via a wired LAN. Note that the wired communication unit 162 is not limited to this form, and may perform communication via, for example, a USB cable.

### Direct Connection Method

Direct connection indicates a form in which apparatuses are wirelessly connected directly (that is, by Peer to Peer) without intervention of an external apparatus such as the AP 131. Direct connection is also called Peer to Peer connection (P2P connection). As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE 802.11 series communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, GO Negotiation in P2P. Note that in the WFD mode in a state before role making is performed, the communication apparatus 151 is neither the master station nor the slave station. More specifically, first, one of devices to communicate with each other issues a device search command and searches for a device to be connected in the WFD mode. After the other device serving as a communication partner is searched, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the terminal apparatus 101) among devices (for example, the terminal apparatus 101 and the communication apparatus 151) to communicate with each other serves as a client that plays a role of requesting various services. The other device implements the function of an AP in Wi-Fi by software setting. The software AP corresponds to a Wi-Fi master station, and the client corresponds to a Wi-Fi slave station. In the software AP mode, the client searches for a device serving as a software AP by a device search command. After the software AP is searched, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station so that the communication apparatus 151 can thus decide a specific frequency band and channel to be used for communication in the direct connection mode. In this embodiment, the communication apparatus 151 can use a channel corresponding to the 2.4-GHz frequency band and a channel corresponding to the 5-GHz frequency band for communication in the direct connection mode. In this embodiment, however, the communication apparatus 151 does not use a channel corresponding to the Dynamic Frequency Selection (DFS) band in the 5-GHz frequency band for communication in the direct connection mode. In other words, the communication apparatus 151 uses only a channel corresponding to a frequency band other than the DFS band in the 5-GHz frequency band for communication in the direct connection mode. Note that if a radar wave in the frequency band corresponding to the channel is detected in a state in which a channel corresponding to the DFS band is used, the channel currently used needs to be changed. The frequency band in which the channel can be changed by detecting a radar wave is called the DFS band. Note that if, for example, a radio chip corresponding to a DFS function is used, it may be possible to use a channel corresponding to the DFS band in the 5-GHz frequency band for communication in the direct connection mode. Note that the channel, which is decided as the channel used in the direct connection mode, is used in the communication via direct connection. Furthermore, this channel is also used to transmit a Beacon signal and a response to a received command as a master station. That is, this channel is used not only for communication processing in the direct connection mode in a state in which direct connection is established, but also for communication processing in the direct connection mode in a state in which direct connection is not established.

Note that the user may be capable of setting whether to use, in the direct connection mode, a channel corresponding to a 2.4-GHz frequency band or a channel corresponding to a 5-GHz frequency band. Furthermore, by accepting a designation of a channel number from the user, the user may be capable of setting the channel number to be used in the direct connection mode. Alternatively, the channel to be used in the direct connection mode may be set in advance in the communication apparatus 151, rather than being arbitrarily set by the user.

Note that the form in which the communication apparatus 151 can use a 2.4-GHz frequency band and a 5-GHz frequency band has been described, but the present disclosure is not limited to this form. The communication apparatus 151 may be capable of using another frequency band, and the other frequency band may be used in the processing where the 2.4-GHz frequency band or 5-GHz frequency band is used in this embodiment. For example, since a 60-GHz frequency band is available in the IEEE 802.11ad standard, the 60-GHz frequency band may be used as the other frequency band described above.

### Infrastructure Connection Method

Infrastructure connection is a connection form in which devices (for example, the terminal apparatus 101 and the communication apparatus 151) to communicate with each other are connected to an AP (for example, the AP 131) that controls a network of the devices, and the devices communicate with each other via the AP. As one connection mode, the communication apparatus 151 can also operate in a mode (infrastructure connection mode) for communication by infrastructure connection.

In infrastructure connection, each device searches for an AP by a device search command. After an AP is searched, the device and the AP perform remaining wireless connection processing (establishment of wireless connection and the like) and then IP connection processing (assignment of an IP address and the like). Note that commands and parameters transmitted/received when implementing wireless connection between the device and the AP suffice to be those defined by the Wi-Fi standard, and a description thereof will be omitted here.

In this embodiment, when the communication apparatus 151 operates in the infrastructure connection, the AP 131 operates as a master station and the communication apparatus 151 operates as a slave unit. That is, in this embodiment, infrastructure connection means connection between the communication apparatus 151 operating as a slave unit and the apparatus operating as a master unit. In a case where the communication apparatus 151 establishes infrastructure connection and the terminal apparatus 101 also establishes infrastructure connection to the AP 131, the communication apparatus 151 and the terminal apparatus 101 can communicate with each other via the AP 131. Since the AP 131 decides a channel to be used for communication in infrastructure connection, the communication apparatus 151 executes communication in infrastructure connection using the channel decided by the AP 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the AP 131, the terminal apparatus 101 needs to recognize that the communication apparatus 151 belongs to a network which is formed by the AP 131 and to which the terminal apparatus 101 belongs.

### Simultaneous Operation

The communication apparatus 151 according to this embodiment can execute an operation by the infrastructure mode and an operation by the direct connection mode simultaneously (in parallel). Accordingly, the communication apparatus 151 can maintain the connection for communication by the infrastructure mode and the connection for communication by the direct connection mode simultaneously (in parallel). In other words, the communication apparatus 151 can establish Wi-Fi connection for which the self-apparatus serves as a slave unit, and Wi-Fi connection for which the self-apparatus serves as a master unit in parallel. Hereinafter, an operation in which infrastructure connection and direct connection are established simultaneously (in parallel) so that communication via the infrastructure connection and communication via the direct connection can be executed simultaneously (in parallel) will be referred to as a simultaneous operation. In other words, the simultaneous operation is an operation in which the communication apparatus 151 executes the operation as a master unit (Group Owner or AP) and the operation as a slave unit in parallel.

Each of communication by the infrastructure mode and communication by the direct connection mode is executed using a specific frequency band (specific channel). Hence, in each of the communication by the infrastructure mode and the communication by the direct connection mode, the channel to be used for communication/connection between apparatuses needs to be decided first before the communication is started. Note that in a form in which a plurality of channels are simultaneously assigned to one radio IC chip for communication, the configurations of the apparatuses that execute communication and the processing operations executed by the apparatuses become complicated. Therefore, for example, when the communication apparatus 151 executes the simultaneous operation, it is desirable to use a common channel in communication in the respective modes. That is, even when the communication apparatus 151 executes the simultaneous operation, it is desirable to use only one channel. Accordingly, in this embodiment, the wireless communication unit 156 includes only a single radio IC chip that implements communication by a predetermined channel, and the communication apparatus 151 does not execute communication using a plurality of channels simultaneously.

### Connection Setting Mode

The communication apparatus 151 can operate in the connection setting mode. A trigger for the communication apparatus 151 to start an operation in the connection setting mode may be, for example, pressing a connection setting mode button by the user or activating (turning on) the communication apparatus 151 for the first time after arrival. The connection setting mode button may be a hardware button of the communication apparatus 151 or a software button displayed on the display unit 161 by the communication apparatus 151.

When the communication apparatus 151 starts an operation in the connection setting mode, it enables both Wi-Fi communication and BLE communication. More specifically, as Wi-Fi communication enabling processing, the communication apparatus 151 enables an internal AP (connection setting AP) of the communication apparatus 151 that is dedicated to the connection setting mode. Then, the communication apparatus 151 can establish direct connection to the terminal apparatus 101 by Wi-Fi. Connection information (SSID and password) for connection to the connection setting AP is held in advance in the setup application installed in the terminal apparatus 101 so that the terminal apparatus 101 recognizes in advance the connection information for connection to the connection setting AP. Note that a form may be adopted in which no encryption method is set for the connection setting AP so no password is required to connect to the AP. Therefore, unlike the connection information of the AP enabled in the direct connection mode, the connection information for connection to the connection setting AP cannot be changed arbitrarily by the user. Note that in the connection setting mode, the communication apparatus 151 may be connected to the terminal apparatus 101 not by normal Wi-Fi but by WFD. That is, the communication apparatus 151 may operate as a group owner and receive a setting command from the terminal apparatus 101 by WFD communication.

Note that when communication is executed via wireless connection between the terminal apparatus 101 and the communication apparatus 151 operating in the connection setting mode, the terminal apparatus 101 may use, as a protocol used for communication, Internet Protocol version 4 (IPv4) or Internet Protocol version 6 (IPv6). For example, if IPv6 is set in the terminal apparatus 101 but the communication apparatus 151 can only execute communication using IPv4, the communication may not be executable. That is, before starting the communication, predetermined processing may be executed for determining whether the communication apparatus 151 can use the protocol used for communication by the terminal apparatus 101. Note that a case where IPv4 is set in the terminal apparatus 101 as the protocol used for communication by the terminal apparatus 101 is a case where communication using IPv4 by the wireless communication unit 109 is enabled in the terminal apparatus 101. Similarly, a case where IPv6 is set in the terminal apparatus 101 as the protocol used for communication by the terminal apparatus 101 is a case where communication using IPv6 by the wireless communication unit 109 is enabled in the terminal apparatus 101.

### Connection Setting Processing

In this embodiment, the terminal apparatus 101 executes setting (wireless setting) for causing the communication apparatus 151 to operate in the infrastructure connection mode by using wireless communication with the communication apparatus 151. The connection setting processing according to this embodiment is executed by wireless communication, and is thus called a cableless setup (CLS). The connection setting processing will be sometimes referred to as the first setup as will be described later. Note that the connection setting processing may be executed using wired communication. The communication apparatus 151 executes the connection setting processing while it operates in the wireless setting mode, which is a mode for executing the connection setting processing. The terminal apparatus 101 executes the connection setting processing while the setup application is running. The setup application is an application program for setting the AP to be connected to the communication apparatus 151, and for causing the communication apparatus 151 to print image data, document data, or the like in the terminal apparatus 101.

Note that the setup application may have another function in addition to a function for executing the connection setting processing, which is processing of setting the AP to be connected to the communication apparatus 151, by transmitting a setting command to the communication apparatus 151, and a function of causing the communication apparatus 151 to execute printing. For example, the setup application may have a function of causing the communication apparatus 151 to scan a document set therein if the communication apparatus 151 has a scan function, a function of performing another setting of the communication apparatus 151, a function of checking the state (status) of the communication apparatus 151, or the like. The setup application may have a function for executing the connection setting processing without having other functions such as the function of causing the communication apparatus 151 to execute printing. The function of causing the communication apparatus 151 to execute printing is, more specifically, a function of transmitting a print job for causing the communication apparatus 151 to execute printing to the communication apparatus 151. The function of causing the communication apparatus 151 to scan a document set therein is, more specifically, a function of transmitting a scan job for causing the communication apparatus 151 to execute scanning to the communication apparatus 151. The function of checking the state of the communication apparatus 151 is, more specifically, a function of acquiring information indicating the status of the communication apparatus 151 from the communication apparatus 151 and displaying it. The setup application is assumed to be an application program.

In the following description, the processing executed by the setup application is implemented, in practice, when the CPU 103 reads out the setup application stored in the ROM 104 into the RAM 105 and executes it. When connecting the AP 131 and the communication apparatus 151 to each other and causing the communication apparatus 151 to operate in the infrastructure connection mode, the terminal apparatus 101 wirelessly transmits an infrastructure setting command (connection setting instruction) for causing the communication apparatus 151 to operate in the infrastructure connection mode to the communication apparatus 151. The infrastructure setting command includes, for example, information concerning the AP 131. The information concerning the AP 131 is, for example, the Service Set Identifier (SSID) of the AP131, a password for connecting to the AP 131, information about the frequency band used by the AP 131, and the like. After infrastructure connection by Wi-Fi is established between the terminal apparatus 101 and the communication apparatus 151 by the connection setting processing, the terminal apparatus 101 and the communication apparatus 151 can communicate with each other via the established connection. More specifically, for example, the terminal apparatus 101 can transmit, to the communication apparatus 151 via the established connection, a print job for causing the communication apparatus 151 to execute printing or a scan job for causing the communication apparatus 151 to execute scanning. In addition, after infrastructure connection is established, the communication apparatus 151 can communicate with the Internet via the AP 131. As an example, the communication apparatus 151 can receive an apparatus update notification from a specific server, download print data, or upload information of the communication apparatus 151.

### Wireless Profile

A wireless profile is information stored and managed by the OS of the terminal apparatus 101, and including the connection information of the AP having connected to the terminal apparatus 101. For example, the wireless profile is used for a reconnection function, which is a function of, when the connection between the terminal apparatus 101 and the AP is disconnected, automatically reestablishing the connection by the OS.

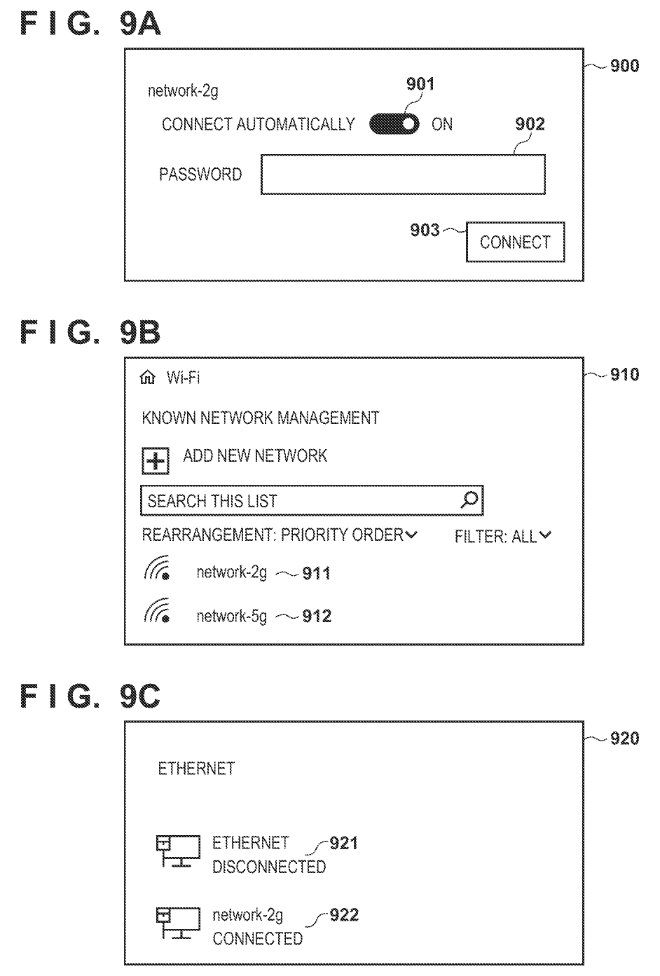

FIG. 9A shows a connection screen 900 which is a screen displayed by the OS and used to connect the terminal apparatus 101 to an AP. Assume that the connection screen 900 is a screen for connecting to the AP 131 having the SSID displayed on the screen 900. The connection screen 900 includes a region 901 for setting whether to enable the reconnection function with respect to the connection with the AP 131, a region 902 for accepting an input of the password for connecting to the AP 131, and a region 903 for attempting to establish a connection between the AP 131 and the terminal apparatus 101 by using the input password. In a case where the reconnection function is set to be enabled by the region 901, if the connection between the terminal apparatus 101 and the AP 131 is disconnected, the OS automatically reestablishes the connection. On the other hand, in a case where the reconnection function is set to be disabled by the region 901, even if the connection between the terminal apparatus 101 and the AP 131 is disconnected, the OS does not automatically reestablish the connection. If the region 903 is pressed and a connection between the AP 131 and the terminal apparatus 101 is successfully established, the OS saves the connection information (SSID and password) of the AP 131 as a wireless profile. However, for a specific type of OS or a specific version of OS, in a case where the reconnection function is set to be disabled, even if a connection between the AP 131 and the terminal apparatus 101 is successfully established, the OS does not save the connection information of the AP 131 as a wireless profile.

FIG. 9B is a wireless profile screen 910 which is a screen displayed by the OS and used to show the stored wireless profile. The wireless profile screen 910 is an example of the screen when the OS stores two wireless profiles. In the wireless profile screen 910, the wireless profile having high priority is displayed in high order. The wireless profile having high priority is the wireless profile that is used preferentially in a state where a connection between the terminal apparatus 101 and an AP is not established. A region 911 is a region where the first wireless profile having high priority is indicated by the SSID, and a region 912 is a region where the second wireless profile having low priority is indicated by the SSID. Note that by executing a predetermined operation on the region 911 or the region 912, it is possible to delete, from the terminal apparatus 101, the wireless profile corresponding to the region where the predetermined operation is executed.

### MAC Address

A Media Access Control Address (MAC address) is information for uniquely identifying a device on a network, and is used to designate the destination of network communication. The MAC address is address information having a length of 48 bits (6 bytes). In general, a MAC address is written in hexadecimal notation, with each byte separated by a dash (-) or a colon (:).

The three most significant bytes of the MAC address represent the vendor ID managed by the IEEE (Institute of Electrical and Electronics Engineers). Hereinafter, the three most significant bytes of the MAC address will be referred to as an Organizationally Unique Identifier (OUI) portion. The three least significant bytes of the MAC address represent the address managed by each vender. Hereinafter, the three least significant bytes of the MAC address will be referred to as a vender management portion. The vender management portion is assigned an address for each product by each vender so as to prevent duplication. By combining the OUI portion and the vendor management portion, the MAC address can serve as a unique identifier assigned for each product.

The least significant bit in the first byte of the MAC address is called the Individual/Group bit (I/G bit), which indicates the network communication method. More specifically, a state in which the I/G bit of the MAC address is set indicates that data is transmitted simultaneously to multiple communication partners. This communication method is called multicast communication (a method of transmitting data to a specific group) or broadcast communication (a method of transmitting data to all terminals within a LAN). On the other hand, a state in which the I/G bit of the MAC address is not set indicates that the communication partner is only a single individual terminal. This communication method is called unicast communication.

The second least significant bit in the first byte of the MAC address is called the Global/Local bit (G/L bit), which indicates the use range of the network device. In general, for a device on a network, the G/L bit of the MAC address is not set, and for a device used in a local network, the G/L bit is often set.

In a case of a wireless communication device, for example, the SSID of an AP is assigned a unique MAC address to specify the destination of network communication. As described above, as the region of the MAC address that is uniquely assigned for each device, each vendor sets a value within a range of the 24-bit vendor management portion. At this time, an AP that can use multiple SSIDs requires a large number of addresses in order to assign a unique MAC address to each SSID. Therefore, for the SSIDs of the same device, each vendor may save bits in the vendor management portion by setting the G/L bit in the OUI portion of the MAC address.

### Wired Profile

A wired profile is information stored and managed by the OS of the terminal apparatus 101, and including the identifier of the network having connected to the terminal apparatus 101 via a wired LAN. The wired profile includes, for example, the MAC address and the network name as the specific information of the connection destination device. When the terminal apparatus 101 is connected to a network via a wired LAN, the OS refers to the wired profile to see if the currently connected network is the same as the previously connected network. For example, the OS acquires the MAC address of the device connected to the terminal apparatus 101 via the wired LAN, and determines whether information including the same MAC address exists in the wired profile. If it is determined that they are the same network, the OS displays, on a predetermined screen of the OS, the wired LAN connection destination network name (to be referred to as the wired profile name hereinafter) acquired during the previous connection.

Note that if the terminal apparatus 101 has connected to a network via a wireless LAN, the SSID as the wireless LAN network name is displayed as the wired profile name. This is done by, when the wireless LAN connection destination device and the wired LAN connection destination device are specified to be the same device, the OS storing and managing the SSID acquired from the wireless profile as the network name in the wired profile.

As a method of specifying that a wireless LAN connection destination device and a wired LAN connection destination device are the same device, for example, the OS acquires and determines the MAC addresses of the connection destination devices. When the terminal apparatus 101 is connected to a device via a wireless LAN, the OS can acquire the MAC address as the specific information of the wireless LAN connection destination device. That is, the MAC address is acquired as the specific information of the network device connected to the terminal apparatus 101 via the wireless LAN. In this case, if the MAC address acquired via the wireless LAN and the MAC address included in the wired profile are specified to be information indicating the same device, the network devices connected to the terminal apparatus 101 can be specified to be the same device. During connecting to a network via a wireless LAN, the OS acquires the MAC address and stores and manages it in a location different from the wireless profile. If it is determined that the MAC address acquired via the wireless LAN and the MAC address acquired via the wired LAN are information of the same device, the OS stores and manages the SSID acquired from the wireless profile as the network name in the wired profile.

The processing in which the OS determines whether the devices are the same device based on the MAC addresses has been described, but the present disclosure is not limited to this. For example, the OS may acquire the IP address of the wireless LAN connection destination and the IP address of the wired LAN connection destination and confirm whether the IP addresses match, thereby determining that the devices are the same device.

FIG. 9C shows a wired profile screen 920 which is a screen displayed by the OS and used to show the stored wired profile. The wired profile screen 920 is an example of the screen when the OS stores two wired profiles. Note that the wired profile screen 920 may be configured to display only the information of the wired profile of the currently connected network. A region 921 is a region where the first wired profile of the unconnected network is indicated by the network name, and a region 922 is a region where the second wired profile of the connected network is indicated by the network name. In a case where only a wired LAN is used to connect, the OS may assign a generic name as the network name. For example, the wired profile screen 920 displays a generic name "Ethernet" in the region 921. For a network device having connected via a wireless LAN, the OS may assign the name of the wireless network as the network name. For example, the wired profile screen 920 displays the network name acquired from the wired profile in the region 922. This is possible by the OS storing the SSID acquired from the wireless profile as the network name in the wired profile.

### Processing Executed by Terminal Apparatus 101 and Communication Apparatus 151

In this embodiment, the setup application can execute the network setup (to be referred to as the first setup hereinafter) of the communication apparatus 151 via wireless connection between the terminal apparatus 101 and the communication apparatus 151 operating in the connection setting mode. In other words, the first setup is a setup method of connecting the communication apparatus 151 and the AP by the setup application transmitting the setting information from the terminal apparatus 101 to the communication apparatus 151 via wireless communication. Note that the setting information includes the password and SSID for connecting to the AP. That is, the first setup (connection setting processing) is processing for transmitting, to the communication apparatus 151, the setting information for connection to the AP which is a wireless LAN router. Note that if the wireless profile corresponding to a predetermined AP serving as the connection partner of the communication apparatus 151 is saved in advance in the terminal apparatus 101 before the setup application accepts, from the user, a predetermined operation (predetermined instruction) for network setup, the setup application can execute the first setup without accepting an input of the password from the user.

In this embodiment, the communication apparatus 151 can connect to the AP using a method other than the first setup. Each of the second setup and the third setup, which is a method other than the first setup, is the network setup performed without the setup application transmitting the setting information from the terminal apparatus 101 to the communication apparatus 151 via wireless communication. More specifically, for example, the second setup is the network setup by push-button Wi-Fi Protected Setup (WPS). The second setup may be the network setup by PIN-code WPS. Alternatively, the second setup may be the network setup by AOSS, Easy Wireless Start, or the like other than WPS. The second setup may be the network setup performed by establishing, using a wireless LAN, a connection between the communication apparatus 151 and the AP selected from the APs searched by the communication apparatus 151 by the user through an operation on the communication apparatus 151.

The third setup as the method other than the first setup is the network setup performed by establishing, using a wired LAN, a connection between the AP and the communication apparatus 151. Note that the third setup may be the network setup implemented when the setup application transmits the setting information from the terminal apparatus 101 to the communication apparatus 151 via USB communication. Each of the second setup and the third setup is a network setup method that can be executed without an input of the password for connecting to the AP by the user to the setup application. If the wireless profile corresponding to a predetermined AP is not saved in advance in the terminal apparatus 101 before the setup application accepts a predetermined instruction from the user, the setup application preferably executes predetermined processing for the setup other than the first setup. This is because many users find the second setup and the third setup more convenient than the first setup which requires the password input operation. More specifically, the predetermined processing is, for example, processing of displaying a selection screen to be described later, or processing of displaying a guide screen to be described later.

The fourth setup, which is a method other than the first setup, the second setup, and the third setup, is a setup method performed by establishing communication between the terminal apparatus 101 and the communication apparatus 151 using USB. The fourth setup can be executed when a network to be connected to the communication apparatus 151 does not exist nearby. Note that the fourth setup may be setup performed by establishing a connection between the terminal apparatus 101 and the communication apparatus 151 using Bluetooth connection.

There may be a case where the user does not have a wireless LAN router and the AP 131 does not exist around the communication apparatus 151. As an example, a case is assumed where, as shown in FIG. 1, the terminal apparatus 101 is connected to the network hub 182 but the AP 131 does not exist around the communication apparatus 151. In such a case, the communication apparatus 151 cannot connect to the AP 131. That is, infrastructure connection via the AP 131 cannot be established between the terminal apparatus 101 and the communication apparatus 151. In this case, the user needs to understand that, in order to execute one of the first setup to the third setup by the terminal apparatus 101, the AP 131 is required to exist around the AP 131. Then, the user needs to select to establish a connection between the terminal apparatus 101 and the communication apparatus 151 by the fourth setup.

However, in the environment where the AP 131 does not exist around the terminal apparatus 101 or the communication apparatus 151, if infrastructure connection cannot be established, the user may come to a stalemate in the operation of the terminal apparatus 101 or the communication apparatus 151. Alternatively, for example, the user may interrupt the setup of the communication apparatus 151 without recognizing the necessity of executing the fourth setup. That is, the terminal apparatus 101 and the communication apparatus 151 cannot communicate with each other. In such a case, the user cannot complete the setup on his/her own and may, for example, end up returning the communication apparatus 151 to the manufacturer. To prevent this, it is demanded to improve user convenience when establishing a connection between the terminal apparatus 101 and the communication apparatus 151.

Therefore, in this embodiment, when executing the setup of the communication apparatus 151 from the terminal apparatus 101, the setup application causes the CPU 103 of the terminal apparatus 101 to operate as follows. The CPU 103 displays a selection screen for selecting the connection method for connecting the communication apparatus 151 to another apparatus. Then, if a selection corresponding to connecting the communication apparatus 151 to the AP 131 by a wireless LAN connection method is performed on the selection screen, the CPU 103 executes predetermined processing for confirming whether the AP 131 exists nearby. In this embodiment, as the predetermined processing, the CPU 103 displays a confirmation screen for prompting the user to confirm whether the AP 131 exists around the communication apparatus 151. If an operation corresponding to confirming that the AP 131 exists around the communication apparatus 151 is performed on the confirmation screen, the CPU 103 executes the first setup for connecting a communication apparatus to the AP 131 by the wireless LAN connection method. On the other hand, if an operation corresponding to confirming that the AP 131 does not exist around the communication apparatus 151 is performed on the confirmation screen, the CPU 103 does not execute the first setup.

In this manner, in this embodiment, before the first setup, the CPU 103 uses the confirmation screen to prompt the user to confirm whether the AP 131 exists around the communication apparatus 151. Based on the user selection on the confirmation screen, the CPU 103 controls whether to execute the first setup. This can prevent the CPU 103 from executing and failing the first setup in the environment where the AP 131 does not exist around the communication apparatus 151.

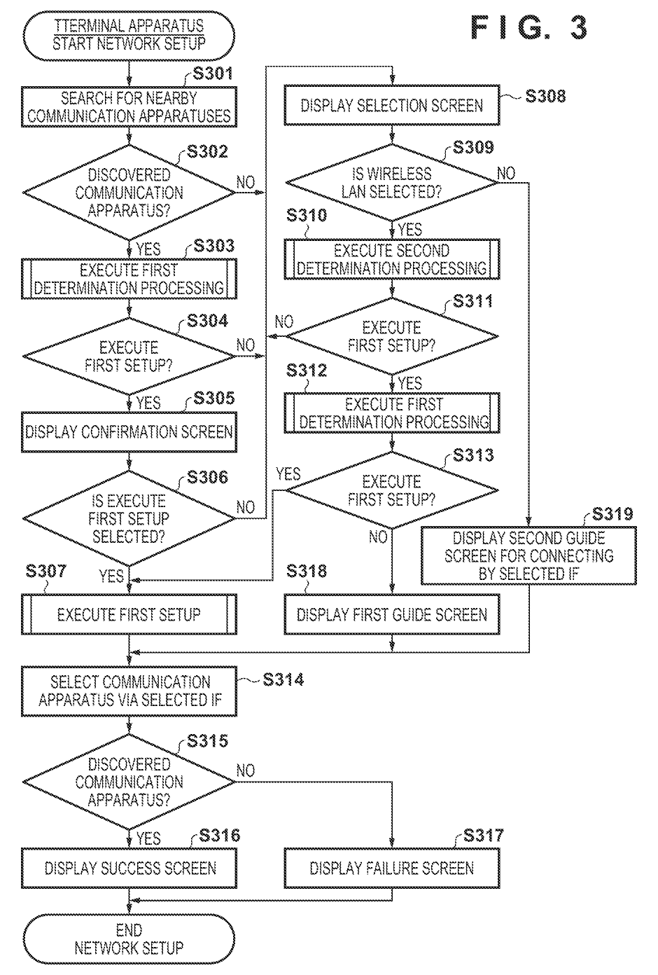

FIG. 3 is a flowchart showing an example of the network setup of the communication apparatus 151, which is executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart is started based on that the user made the above-described predetermined instruction on a screen displayed by the setup application.

In step S301, the CPU 103 searches for a communication apparatus 151 operating in the connection setting mode (as the connection setting AP). More specifically, the CPU 103 searches for a beacon which is generated by a communication apparatus 151 operating in the connection setting mode and includes the SSID corresponding to the connection setting mode.

In step S302, the CPU 103 determines whether a communication apparatus 151 operating in the connection setting mode is discovered through the search in step S301. More specifically, the CPU 103 determines whether a beacon including the SSID corresponding to the connection setting mode is included in beacons detected in step S301. The SSID corresponding to the connection setting mode is the same SSID as the connection information for connection to a connection setting AP, which is held in advance in the setup application. Hence, the CPU 103 determines whether the beacon including the same SSID as the connection information for connection to a connection setting AP, which is held in advance in the setup application, is included in the beacons generated by the apparatuses around the terminal apparatus 101. If YES is determined, the CPU 103 advances to step S303. If NO is determined, the CPU 103 advances to step S308. In addition, if YES is determined, the CPU 103 specifies the discovered communication apparatus 151 as the network setup target apparatus (to be referred to as the target apparatus hereinafter). Note that if multiple communication apparatuses 151 are discovered, the communication apparatus 151 which is discovered first may be specified as the target apparatus, or the communication apparatus 151 selected by the user from the multiple discovered communication apparatuses 151 may be specified as the target apparatus. In the following description, processing for the network setup is performed for the communication apparatus 151 specified as the target apparatus.

In step S303, the CPU 103 executes the first determination processing for determining whether to execute the first setup without execution of predetermined processing for accepting an input of the password from the user. Details of the first determination processing will be described later with reference to FIG. 4.

In step S304, the CPU 103 determines whether, in the first determination processing, it is determined to execute the first setup without execution of the predetermined processing. If YES is determined, the CPU 103 advances to step S305. It if is determined NO, the CPU 103 advances to step S308. If YES is determined, the CPU 103 executes the first setup without executing processing concerning the setup other than the first setup, such as displaying the selection screen or displaying the guide screen (to be described later). On the other hand, if NO is determined, the CPU 103 executes processing concerning the setup other than the first setup, such as displaying the selection screen or displaying the guide screen (to be described later).

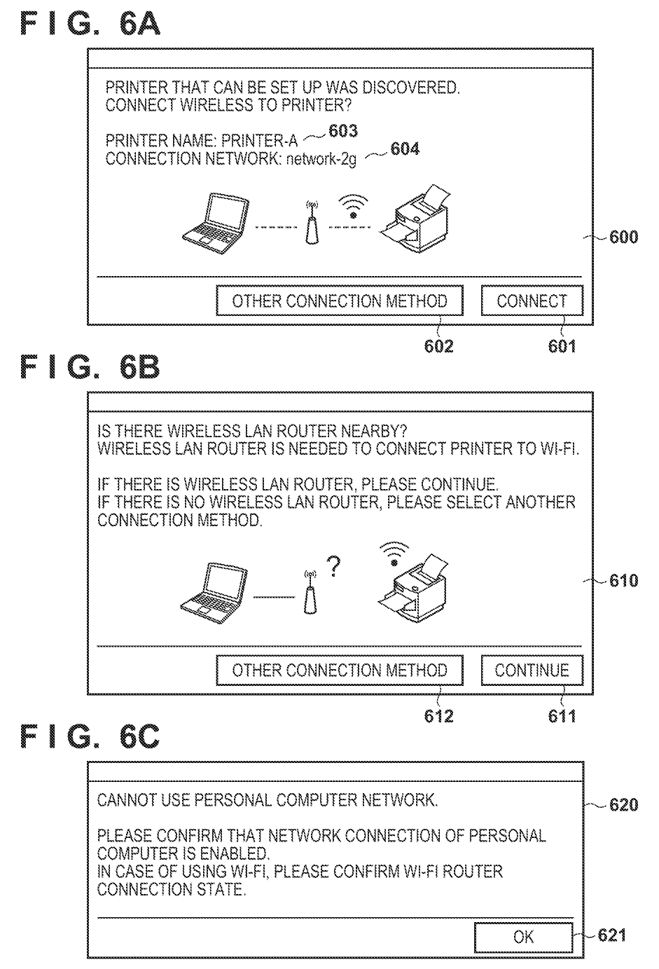

In step S305, the CPU 103 displays, on the display unit 108, a confirmation screen for confirming whether to execute the first setup. Here, for example, a confirmation screen 600 shown in FIG. 6A is displayed. For example, the confirmation screen 600 includes a button 601 for selecting executing the first setup, and a button 602 for selecting not executing the first setup. The confirmation screen 600 also includes a region 603 where the name of the communication apparatus 151 is shown, and a region 604 where the SSID of the network currently connected to the terminal apparatus 101 is shown. The name of the communication apparatus 151 is included in the beacon acquired from the communication apparatus 151 through the search in step S301. The SSID of the network currently connected to the terminal apparatus 101 is acquired in the first determination processing.

In step S306, the CPU 103 determines whether executing the first setup is selected on the confirmation screen 600. More specifically, in this determination, the CPU 103 determines YES if the button 601 is selected, and determines NO if the button 602 is selected. If YES is determined, the CPU 103 advances to step S307. If NO is determined, the CPU 103 advances to step S308.

Note that the processing in steps S305 and S306 may be omitted. That is, after YES is determined in step S304, the CPU 103 may advance to step S307 without executing the processing in steps S305 and S306.

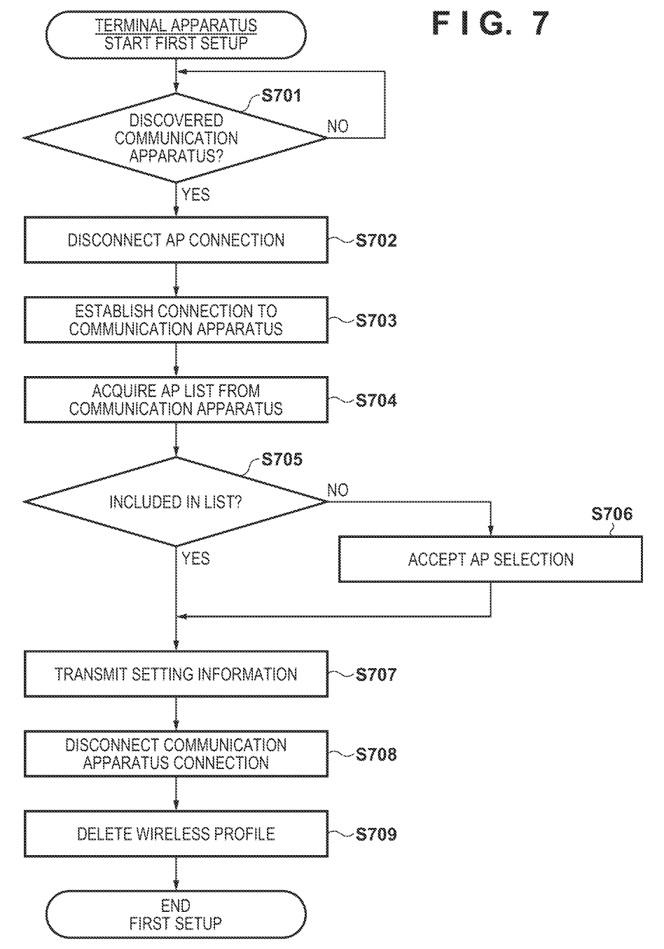

In step S307, the CPU 103 executes the first setup. Details of this processing will be described later with reference to Fig.7. Then, the CPU 103 advances to step S314.

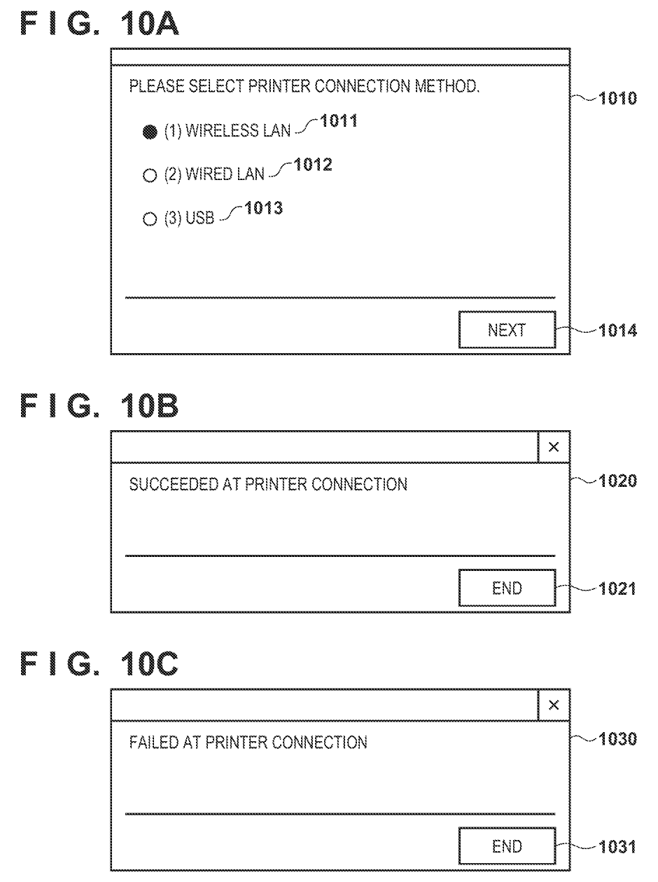

As described above, the processing in step S308 is executed if NO is determined in step S302, if NO is determined in step S304, or if NO is determined in step S306. In step S308, the CPU 103 accepts a selection of the connection method between the terminal apparatus 101 and the communication apparatus 151 from the user. Here, for example, a selection screen 1010 shown in FIG. 10A is displayed on the display unit 108. The selection screen 1010 is a screen for selecting the connection method for connecting the communication apparatus 151 to another apparatus. For example, the selection screen 1010 includes a region 1011 for selecting the wireless LAN connection method (connection method), a region 1012 for selecting the wired LAN connection method, a region 1013 for selecting the USB connection method, and a button 1014 for displaying the next screen. That is, the selection screen 1010 is an acceptance screen capable of accepting a user selection corresponding to connecting the communication apparatus 151 to an AP or the terminal apparatus 101 by one of these connection methods.

Note that the network setup for establishing a connection between the terminal apparatus 101 and the communication apparatus 151 by the wireless LAN connection method includes the first setup and the second setup. Hence, in this embodiment, the setup that can be executed if the region 1011 is selected includes the first setup and the second setup. In other words, the region 1011 is an option corresponding to at least the second setup. The network setup for establishing a connection between the terminal apparatus 101 and the communication apparatus 151 by the wired LAN connection method includes the third setup. Hence, in this embodiment, the setup that can be executed if the region 1012 is selected includes the third setup. In other words, the region 1012 is an option corresponding to at least the third setup. The network setup for establishing a connection between the terminal apparatus 101 and the communication apparatus 151 using the USB connection method includes the fourth setup. Hence, in this embodiment, the setup that can be executed if the region 1013 is selected includes the fourth setup. In other words, the region 1013 is an option corresponding to at least the fourth setup. The selection screen 1010 may also include a region for selecting the Bluetooth connection method. If the region for selecting the USB connection method is selected, the USB connection setup is executed as the fourth setup. If the region for selecting the Bluetooth connection method is selected, the Bluetooth connection setup is executed as the fourth setup.

If either selection method is selected by the user selecting one of the regions 1011 to 1013 and then the button 1014 is pressed by the user, the CPU 103 advances to step S309.

In step S309, the CPU 103 determines whether the wireless LAN connection method is selected on the selection screen 1010. If YES is determined, the CPU 103 advances to step S310. If NO is determined, the CPU 103 advances to step S319.

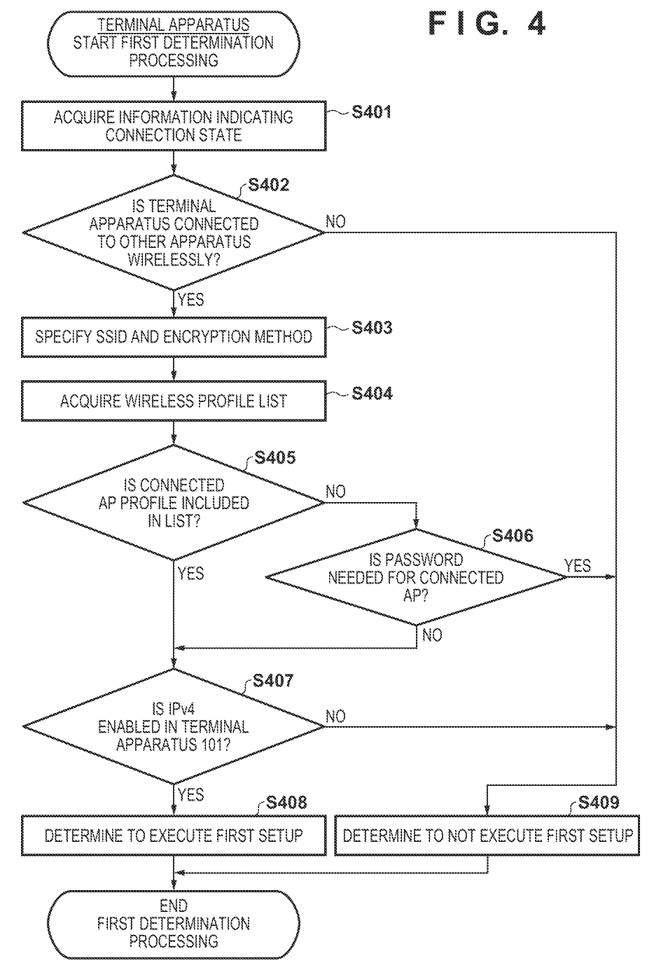

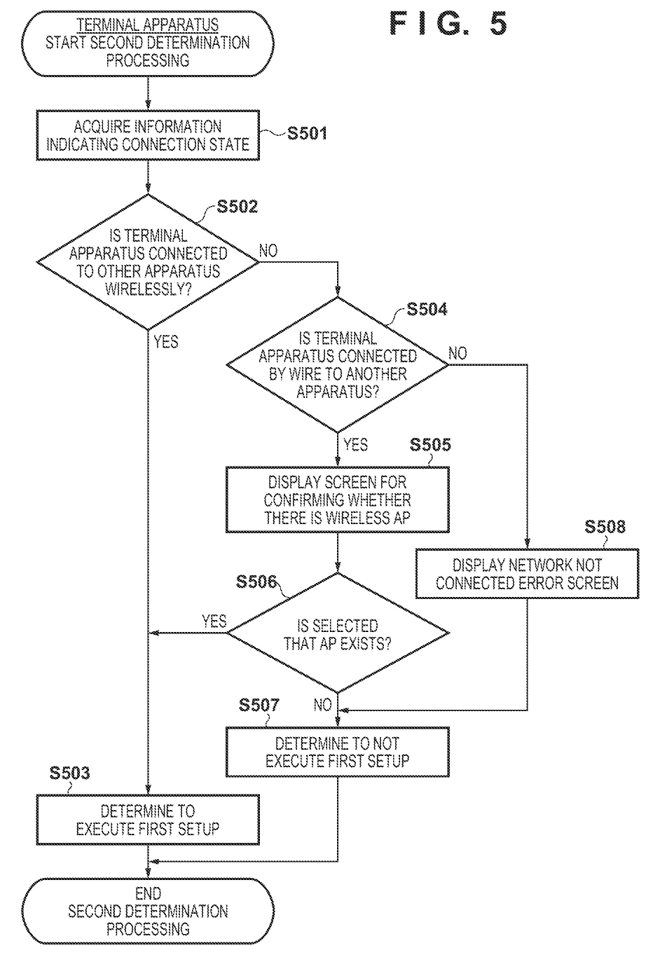

In step S310, the CPU 103 executes the second determination processing for determining whether to execute the first setup. Details of the second determination processing will be described later with reference to FIG. 5.

In step S311, the CPU 103 determines whether it is determined to execute the first setup in the second determination processing. If YES is determined, the CPU 103 advances to step S312. If NO is determined, the CPU 103 advances to step S308. That is, in this embodiment, if the first setup is not executed (NO in step S311), the CPU 103 displays the selection screen 1010 again in step S308. By displaying the selection screen 1010 again in this manner, the user can select another setup method.

In step S312, the CPU 103 executes the first determination processing for determining whether to execute the first setup. Details of the first determination processing will be described later with reference to FIG. 4. As the first determination processing in step S312 and the first determination processing in step S303, the CPU 103 executes the same processing.

In step S313, the CPU 103 determines whether it is determined to execute the first setup in the first determination processing. If YES is determined, the CPU 103 advances to step S307. If NO is determined, the CPU 103 advances to step S318.

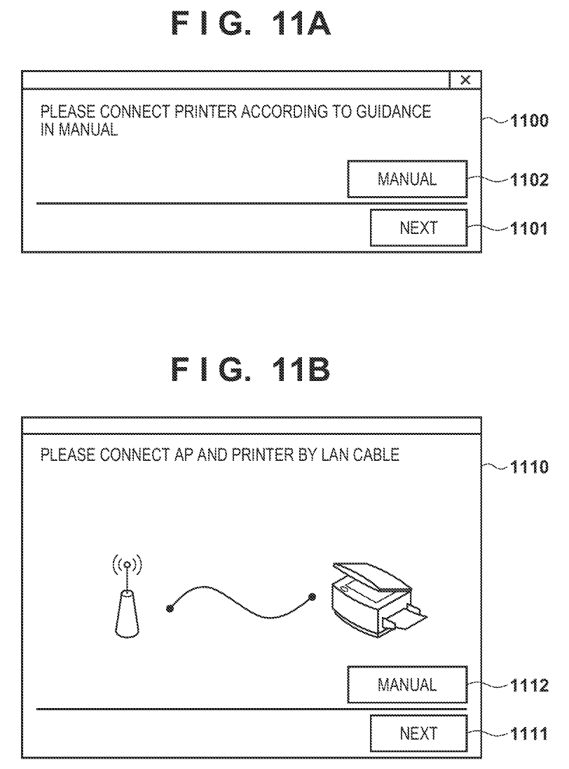

In step S318, the CPU 103 displays the first guide screen for the second setup on the display unit 108. Here, for example, a guide screen 1100 shown in FIG. 11A is displayed as the first guide screen on the display unit 108. For example, the guide screen 1100 includes a button 1102 for displaying a manual, which shows the operation method for the user to execute the second setup, on the WEB browser of the terminal apparatus 101, and a button 1101 for displaying the next screen. If the region (button) 1102 is selected, the CPU 103 activates the WEB browser of the terminal apparatus 101, and displays the above-described manual on the WEB browser. Note that the processing is not limited to this, and the above-described manual may be displayed not on the WEB browser but directly on the setup application. If the button 1101 is pressed by the user, the CPU 103 advances to step S314.

In step S319, the CPU 103 displays the second guide screen for the third setup or the fourth setup on the display unit 108. Here, for example, a guide screen 1110 shown in FIG. 11B is displayed as the second guide screen on the display unit 108. For example, the guide screen 1110 includes a button 1112 for displaying a manual, which shows the operation method for the user to execute the third setup or the fourth setup, on the WEB browser of the terminal apparatus 101, and a button 1111 for displaying the next screen. Alternatively, the method itself that allows the user to execute the third setup or the fourth setup may be included in the guide screen 1110. More specifically, for example, a region prompting the user to connect the AP 131 and the communication apparatus 151 via the wired LAN (LAN cable) may be included in the guide screen 1110. In a case where the third setup or the fourth setup is the USB connection setup, the guide screen 1110 may be a screen for prompting the user to connect the terminal apparatus 101 and the communication apparatus 151 using a USB cable. In a case where the fourth setup is the Bluetooth connection setup, the guide screen 1110 may be a screen for prompting the user to connect the terminal apparatus 101 and the communication apparatus 151 using Bluetooth.

In step S314, the CPU 103 searches for the communication apparatus 151 in accordance with the method executed among the first setup to the fourth setup. For example, if one of the first setup, the second setup, and the third setup is executed, the CPU 103 searches for the communication apparatus 151 on the network which is formed by the AP 131 and to which the terminal apparatus 101 belongs. If one of the first setup, the second setup, and the third setup is executed so that the communication apparatus 151 and the terminal apparatus 101 are connected to the same AP 131, the communication apparatus 151 is discovered through this search. For example, in a case where the fourth setup is executed, the CPU 103 searches for the communication apparatus 151 connected to the terminal apparatus 101 via USB. More specifically, the CPU 103 acquires the information of the apparatus around the terminal apparatus 101 by using the Application Program Interface (API) of the OS of the terminal apparatus 101. More specifically, the CPU 103 acquires the information of the communication apparatus 151 connected to the wired communication unit 112 via USB.

In step S315, the CPU 103 determines whether the communication apparatus 151 has been discovered through the search in step S314. If YES is determined, the CPU 103 advances to step S316. If NO is determined, the CPU 103 advances to step S317. Note that in a case where this processing is executed after the first setup, the CPU 103 specifies whether the communication apparatus 151 to which the setting information has been transmitted by the first setup is included in one or multiple apparatuses discovered through the search in step S314. If it is specified that the communication apparatus 151 is included, YES is determined in this determination. That is, if no apparatus is discovered through the search in step S314, or if the communication apparatus 151 to which the setting information has been transmitted by the first setup is not included in one or multiple discovered apparatuses, NO is determined in this determination. In a case where this processing is executed after the second setup or the third setup, the CPU 103 displays one or multiple apparatuses discovered through the search in step S314, and accepts a selection from the user. If a selection from the user is accepted, YES is determined in this determination. That is, if no apparatus is discovered through the search in step S314 and no selection is accepted from the user, NO is determined in this determination. In a case where this processing is executed after the fourth setup, if one or more apparatuses are discovered through the search in step S314, the CPU 103 determines YES in this determination. That is, if no apparatus is discovered through the search in step S314, NO is determined in this determination.

In step S316, the CPU 103 displays a success screen on the display unit 108, which is a screen corresponding to a fact that the communication apparatus 151 has been discovered through the search in step S314. Here, for example, a success screen 1020 shown in FIG. 10B is displayed on the display unit 108. For example, the success screen 1020 includes a message indicating that the communication apparatus 151 has been discovered, or a message indicating that the connection with the communication apparatus 151 has been successful. If an end button 1021 included in the success screen 1020 is pressed, the processing of this flowchart ends.

Note that in the case where the communication apparatus 151 has been discovered through the search in step S314, the CPU 103 may acquire capability information concerning the capability of the communication apparatus 151 from the communication apparatus 151. The capability information may be used in print setting processing for performing setting of a print job transmitted to the communication apparatus 151, or scan setting processing for performing setting of a scan job transmitted to the communication apparatus 151. The capability information is, for example, information indicating the sheet type available for printing, information indicating whether a scanning operation can be executed, or the like.

In the case where the communication apparatus 151 has been discovered through the search in step S314, for example, the CPU 103 may execute processing for installing a printer driver corresponding to the communication apparatus 151. More specifically, for example, the CPU 103 may install an installer for installing a printer driver corresponding to the communication apparatus 151, and install the printer driver using the installer.

In step S317, the CPU 103 displays a failure screen on the display unit 108, which is a screen corresponding to a fact that the communication apparatus 151 could not be discovered through the search in step S314. Here, for example, a failure screen 1030 shown in FIG. 10C is displayed on the display unit 108. For example, the failure screen 1030 includes a message indicating that the communication apparatus 151 could not be discovered, or a message indicating that the connection with the communication apparatus 151 has failed. If an end button 1031 included in the failure screen 1030 is pressed, the processing of this flowchart ends.

FIG. 4 is a flowchart illustrating the first determination processing executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to the processing in step S303 and the processing in step S312.

In step S401, the CPU 103 acquires information indicating the connection state of the terminal apparatus 101 from the OS of the terminal apparatus 101 by using the API of the OS. More specifically, in step S401, as information indicating the connection state of the terminal apparatus 101, the CPU 103 acquires information indicating the connection state of the wireless communication unit 109 from the OS. In other words, the connection state of the wireless communication unit 109 is the Wi-Fi connection state of the terminal apparatus 101. In other words, the connection state of the wireless communication unit 109 is information indicating whether the terminal apparatus 101 is connected to another apparatus via the wireless LAN.

In step S402, based on the information indicating the connection state of the terminal apparatus 101 acquired in step S401, the CPU 103 determines whether the terminal apparatus 101 is connected to another apparatus via the wireless LAN. If YES is determined, the CPU 103 advances to step S403. If NO is determined, the CPU 103 advances to step S409.

In step S403, the CPU 103 specifies the SSID of the AP connected to the terminal apparatus 101, and the encryption method used by the AP connected to the terminal apparatus 101.

In step S404, the CPU 103 acquires a list of wireless profiles held by the terminal apparatus 101 from the OS of the terminal apparats 101. The wireless profile held by the terminal apparatus 101 is information concerning the AP having connected to the terminal apparatus 101. More specifically, the wireless profile held by the terminal apparatus 101 is the SSID of the AP having connected to the terminal apparatus 101, and the password for connecting to the AP having connected to the terminal apparatus 101.

In step S405, the CPU 103 determines whether the wireless profile corresponding to the AP connected to the terminal apparatus 101 is included in the list acquired in step S404. If YES is determined, the CPU 103 advances to step S407. If NO is determined, the CPU advances to step S406. The case where YES is determined corresponds to a case where the wireless profile corresponding to the AP connected to the terminal apparatus 101 is saved in advance in the terminal apparatus 101 before the setup application accepts a predetermined instruction from the user. As described above, depending on the type or version of OS of the terminal apparatus 101, in a state in which setting of disabling the reconnection function is made, even if a new AP is connected, the OS does not save the wireless profile concerning the AP. Therefore, the case where the wireless profile corresponding to the AP connected to the terminal apparatus 101 is not included in the list acquired in step S404 is a case where the wireless profile has not been saved since the setting is enabled.

In step S406, based on the encryption method specified in step S403, the CPU 103 determines whether the password is required to connect to the AP connected to the terminal apparatus 101. The case where the password is required to connect to the AP connected to the terminal apparatus 101 is a case where, in step S403, an encryption method such as Wired Equivalent Privacy (WEP), Wi-Fi Protected Access (WPA), WPA2, or WPA3 is specified as the encryption method set in the AP connected to the terminal apparatus 101. On the other hand, the case where the password is not required to connect to the AP connected to the terminal apparatus is a case where no encryption method is set in the AP connected to the terminal apparatus 101 so no encryption method is specified in step S403. This also includes a case where the network formed by the AP connected to the terminal apparatus 101 is an open network. If YES is determined, the CPU 103 advances to step S409. If NO is determined, the CPU 103 advances to step S407.

In step S407, based on the information acquired in step S401, the CPU 103 determines whether communication by the wireless communication unit 109 using IPv4 is set to be enabled in the terminal apparatus 101. If YES is determined, the CPU 103 advances to step S408. If NO is determined, the CPU 103 advances to step S409.

In step S408, the CPU 103 determines to execute the first setup without execution of predetermined processing. Note that this determination result is referred to in each of steps S304 and S313. After step S408, the CPU 103 terminates the processing of this flowchart.

In step S409, the CPU 103 determines not to execute the first setup without execution of predetermined processing. This determination result is referred to in each of steps S304 and S313. After step S409, the CPU 103 terminates the processing of this flowchart.

FIG. 5 is a flowchart illustrating the second determination processing executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to the processing in step S310.

In step S501, the CPU 103 acquires information indicating the connection state of the terminal apparatus 101 from the OS of the terminal apparatus 101 by using the API of the OS. More specifically, in step S501, as information indicating the connection state of the terminal apparatus 101, the CPU 103 acquires information indicating the connection state of the wireless communication unit 109 and information indicating the connection state of the wired communication unit 112 from the OS. In other words, the information indicating the connection state of the wireless communication unit 109 is information indicating whether the terminal apparatus 101 is connected to another apparatus via the wireless LAN. In other words, the information indicating the connection state of the wired communication unit 112 is information indicating whether the terminal apparatus 101 is connected to another apparatus via the wired LAN. In this embodiment, the information acquired in step S501 is information that cannot specify the specific type of another apparatus connected to the terminal apparatus 101. That is, the information acquired in step S501 does not include identification information for identifying another apparatus connected to the terminal apparatus 101.

In step S502, based on the information indicating the connection state of the wireless communication unit 109 acquired in step S501, the CPU 103 determines whether the terminal apparatus 101 is connected to another apparatus via the wireless LAN. If YES is determined, the CPU 103 advances to step S503. If NO is determined, the CPU 103 advances to step S504.

In step S503, the CPU 103 determines to execute the first setup. This determination result is referred to in step S311. After step S503, the CPU 103 terminates the processing of this flowchart.

If the CPU 103 determines in step S502 that the terminal apparatus 101 is connected to another apparatus via the wireless LAN, the AP 131 may exist around the communication apparatus 151. Accordingly, in this embodiment, if YES is determined in step S502, the CPU 103 advances to step S503 and determines to execute the first setup without displaying a confirmation screen 610 to be described later.

In step S504, based on the information indicating the connection state of the wired communication unit 112 acquired in step S501, the CPU 103 determines whether the terminal apparatus 101 is connected to another apparatus via the wired LAN. If YES is determined, the CPU 103 advances to step S505. If NO is determined, the CPU 103 advances to step S508.

In step S505, the CPU 103 displays, on the display unit 108, a confirmation screen for prompting the user to confirm whether the AP 131 exists around the communication apparatus 151. Here, the terminal apparatus 101 is not connected to another apparatus via the wireless LAN. In addition, the terminal apparatus 101 is connected to another apparatus via the wired LAN. As an example of the terminal apparatus 101 being in such a state, the terminal apparatus 101 may be connected to the network hub 182 via the wired LAN, or may be connected to the AP 131 via the wired LAN. As described above, in this embodiment, the CPU 103 cannot specify the specific type of another apparatus connected to the terminal apparatus 101 from the information acquired in step S501. That is, the CPU 103 cannot determine whether the current situation of the terminal apparatus 101 is the former case or the latter case. In the former case, the AP 131 may not exist around the communication apparatus 151 and the terminal apparatus 101. If the AP 131 does not exist around the communication apparatus 151, even if the user selects the wireless LAN (region 1011) on the selection screen 1010, infrastructure connection via the AP 131 cannot be established between the terminal apparatus 101 and the communication apparatus 151. To prevent this, in this embodiment, if a selection corresponding to connecting the communication apparatus 151 to another apparatus by the wireless LAN connection method (a selection of the wireless LAN (region 1011)) is performed on the selection screen 1010, the CPU 103 displays the confirmation screen described below.

More specifically, in step S505, the CPU 103 displays the confirmation screen 610 shown in FIG. 6B on the display unit 108. For example, the confirmation screen 610 includes a button 611 that can accept a user selection to continue the processing, and a button 612 that can accept a user selection to select another connection method.

The confirmation screen 610 displays a message prompting the user to confirm whether the AP 131 exists around the terminal apparatus 101. This message can make the user confirm whether the AP 131 exists around the terminal apparatus 101. The confirmation screen 610 also displays a message indicating that the AP 131 is required for infrastructure connection of the communication apparatus 151. This message can make the user recognize that the AP 131 is required in a case where, for example, the user selects the wireless LAN 1011 on the selection screen 1010 although the AP 131 does not exist nearby.

The confirmation screen 610 also displays a message prompting the user to press the button 611 if the AP 131 exists around the terminal apparatus 101. The confirmation screen 610 also displays a message prompting the user to press the button 612 if the AP 131 does not exist around the terminal apparatus 101. These messages can make the user appropriately press the button 611 or the button 612 depending on whether the AP 131 exists around the terminal apparatus 101. Note that the confirmation screen 610 may display the information with respect to the user by using another method such as icons or moving images corresponding to these messages.

In step S506, the CPU 103 determines whether it is selected on the confirmation screen 610 that the AP 131 exists nearby. More specifically, in this determination, the CPU 103 determines YES if the button 611 is selected, and determines NO if the button 612 is selected. If YES is determined, the CPU 103 advances to step S503. If NO is determined, the CPU 103 advances to step S507.

In step S507, the CPU 103 determines not to execute the first setup. This determination result is referred to in step S311. After step S507, the CPU 103 terminates the processing of this flowchart.

In this manner, in this embodiment, if an operation corresponding to that the AP 131 exists around the communication apparatus 151 is performed on the confirmation screen 610, the CPU 103 determines to execute the first setup in step S503. On the other hand, if an operation corresponding to that the AP 131 does not exist around the communication apparatus 151 is performed on the confirmation screen 610, the CPU 103 determines not to execute the first setup in step S507. That is, before the first setup, the CPU 103 uses the confirmation screen 610 to make the user confirm whether the AP 131 exists around the communication apparatus 151. Then, based on the user selection on the confirmation screen 610, the CPU 103 controls whether to execute the first setup. Thus, it is possible to prevent the CPU 103 from executing and failing the first setup in the environment where the AP 131 does not exist around the communication apparatus 151.

In step S508, the CPU 103 notifies that the terminal apparatus 101 is not connected to an external network. More specifically, the CPU 103 displays an error screen on the display unit 108. Here, for example, an error screen 620 shown in FIG. 6C is displayed. For example, the error screen 620 includes a button 621 that can accept a user instruction for closing the error screen 620.

The error screen 620 also displays a message indicating that the terminal apparatus 101 is not connected to an external network. Here, the CPU 103 has accepted the user selection of the wireless LAN 1011 on the selection screen 1010 in the processing in step S308. However, the CPU 103 has determined in the processing in steps S502 and S504 that the terminal apparatus 101 is not connected to another apparatus via the wireless LAN and the wired LAN. Therefore, in step S508, by notifying that the terminal apparatus 101 is not connected to an external network, the CPU 103 can make the user recognize that the terminal apparatus 101 is not in a state where infrastructure connection can be established.

The error screen 620 also displays a message prompting the user to confirm whether the network setting of the terminal apparatus 101 is enabled. The error screen 620 also displays a message prompting the user to confirm the connection state of the AP 131. By displaying these messages on the error screen 620, it is possible to improve convenience when the user operates the terminal apparatus 101 to connect the terminal apparatus 101 to the AP 131. Note that the error screen 620 may display a message prompting the user to confirm whether the AP 131 exists around the terminal apparatus 101.

In this manner, if it is determined in step S504 that the terminal apparatus 101 is not connected to another apparatus via the wired LAN, the CPU 103 advances to step S508 and displays the error screen 620. After that, the CPU 103 determines not to execute the first setup in step S507. If the terminal apparatus 101 is not connected to an external network, the AP 131 may not exist around the communication apparatus 151. Therefore, if NO is determined in step S504, the CPU 103 does not execute the first setup without displaying the confirmation screen 610 in step S505. With this, in the case where the AP 131 does not exist around the communication apparatus 151, executing the first setup is prevented.

Note that in this embodiment, in the second determination processing, the CPU 103 advances to step S505 if YES is determined in step S504. However, the processing is not limited to this. In the second determination processing, the CPU 103 may execute the processing as follows.

For example, in the second determination processing, the CPU 103 may skip the processing in steps S501 to S504 and execute the processing in step S505. That is, if the user selects the wireless LAN 1011 on the selection screen 1010 displayed in step S308, the CPU 103 may display the confirmation screen 610 regardless of the connection state of the terminal apparatus 101.

Alternatively, for example, in the second determination processing, if NO is determined in step S502, the CPU 103 may skip the processing in step S504 and execute the processing in step S505. That is, if the user selects the wireless LAN 1011 on the selection screen 1010 displayed in step S308 and the terminal apparatus 101 is not connected to another apparatus via the wireless LAN, the CPU 103 may display the confirmation screen 610.

Even with these forms, the CPU 103 can also make the user confirm on the confirmation screen 610 whether the AP 131 exists nearby. In addition, even with these forms, the CPU 103 can appropriately determine, based on the user operation on the confirmation screen 610, whether to execute the first setup.

FIG. 7 is a flowchart illustrating the first setup executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to the processing in step S307.

In step S701, the CPU 103 searches for the communication apparatus 151 operating in the connection setting mode. Then, it is determined whether the communication apparatus 151 operating in the connection setting mode is discovered. This processing is performed similarly to the processing in steps S301 and S302, so that a detailed description will be omitted. If YES is determined, the CPU 103 advances to step S702. If NO is determined, the CPU 103 returns to step S701 and repeats the search. Note that if the communication apparatus 151 operating in the connection setting mode has been already discovered in step S302, this processing may be omitted.

In step S702, if the terminal apparatus 101 is connected to an AP using the wireless communication unit 109, the CPU 103 disconnects the connection between the terminal apparatus 101 and the AP. At this time, the CPU 103 stores the connection information for connection to the AP in a memory such as the ROM 104. Note that this AP can be considered as the AP connected to the terminal apparatus 101 when a predetermined operation for the network setup of the communication apparatus 151 is performed. This AP can also be considered as the AP connected to the terminal apparatus 101 immediately before a wireless connection between the communication apparatus 151 and the terminal apparatus 101 is established in step S703.

In step S703, the CPU 103 establishes a wireless connection between the terminal apparatus 101 and the communication apparatus 151 operating in the connection setting mode. That is, in step S703, a direct wireless connection is established between the terminal apparatus 101 and the communication apparatus operating in the connection setting mode.

In step S704, the CPU 103 transmits an information acquisition request to the communication apparatus 151 to acquire, from the communication apparatus 151, a list of APs discovered by the communication apparatus 151 through a search. In other words, a list of APs discovered by the communication apparatus 151 through a search is a list of networks discovered by the communication apparatus 151 through a search. The list includes the SSID and the like of the AP discovered by the communication apparatus 151 through a search.

In step S705, the CPU 103 determines whether the list acquired in step S704 includes the SSID of the AP corresponding to the connection information stored in step S702. If YES is determined, the CPU 103 advances to step S707. If NO is determined, the CPU 103 advances to step S706. If YES is determined, the CPU 103 specifies the AP corresponding to the connection information stored in step S702 as the AP to be connected to the communication apparatus 151.

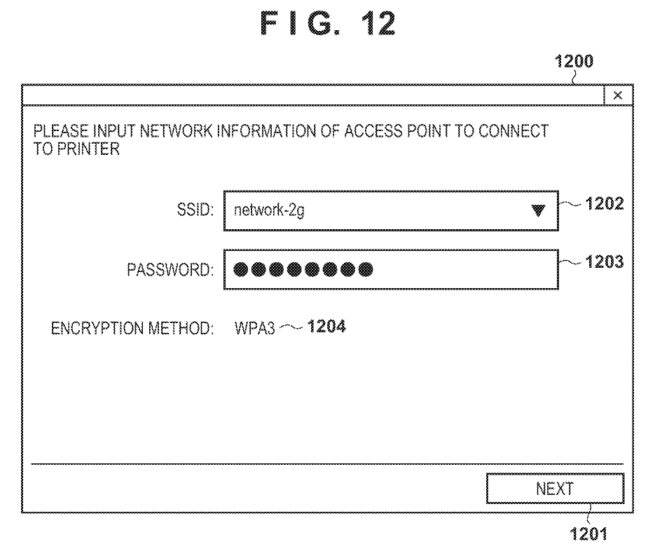

In step S706, the CPU 103 displays the list acquired in step S704, and accepts a user selection of one AP from the list. In other words, a selection of the AP is a selection of the network formed by the AP. The CPU 103 specifies the AP selected by the user as the AP to be connected to the communication apparatus 151. In this processing, for example, a screen as shown in FIG. 12 is displayed as an input screen 1200 for accepting the AP selection from the user. The input screen 1200 includes a region 1202 for accepting an AP selection from the user, a region 1203 for accepting an input of the password for connecting to the AP selected by the user, a region 1204 indicating the encryption method used by the AP selected by the user, and a region 1201 for specifying the AP corresponding to the input information as the AP to be connected to the communication apparatus 151. When the region 1202 is selected, the list acquired in step S704 is displayed in a drop-down format.

Note that if the OS of the terminal apparatus 101 already holds, as the wireless profile, the password used to connect to the AP selected by the user, the CPU 103 may not accept an input of the password from the user. If the AP selected by the user is not set with the encryption method and no password is required to connect to the AP, the CPU 103 may not accept an input of the password from the user. Instead of accepting the AP selected from the list acquired in step S704, the CPU 103 may accept an input of an arbitrary SSID or password from the user, thereby specifying the AP corresponding to the input information as the AP to be connected to the communication apparatus 151. When the region 1201 is selected, the CPU 103 saves the information selected or input on the input screen 1200 as the setting information in order to transmit the setting information. Note that at this time, the CPU 103 may perform processing of verifying whether the information selected or input on the input screen 1200 is correct. More specifically, the CPU 103 may verify whether the input password matches the format of the encryption method used by the selected AP.

In step S707, the CPU 103 transmits, to the communication apparatus 151, the setting information concerning the AP specified as the AP to be connected to the communication apparatus 151. That is, the setting information is transmitted from the terminal apparatus 101 to the communication apparatus 151 via the wireless LAN. In this manner, by transmitting the setting information to the communication apparatus 151 via the wireless LAN, a user operation such as inputting the setting information on the communication apparatus 151 is not required, and convenience can be improved. The setting information includes the connection information (SSID and password) for connecting to the AP specified as the AP to be connected to the communication apparatus 151.

In step S708, the CPU 103 disconnects the wireless connection between the terminal apparatus 101 and the communication apparatus 151 operating in the connection setting mode. Then, the CPU 103 establishes a connection between the terminal apparatus 101 and the AP corresponding to the connection information stored in step S702 by using the connection information stored in step S702. Note that, at this time, the CPU 103 may establish a connection between the terminal apparatus 101 and the AP corresponding to the connection information transmitted in step S707 by using the connection information transmitted in step S707.

In step S709, if the connection information for connection to the communication apparatus 151 operating in the connection setting mode is saved as a wireless profile by the OS, the CPU 103 deletes the wireless profile. This suppresses that the wireless connection between the terminal apparatus 101 and the communication apparatus 151 operating in the connection setting mode is established again at a timing not intended by the user. After that, the processing of this flowchart is terminated.

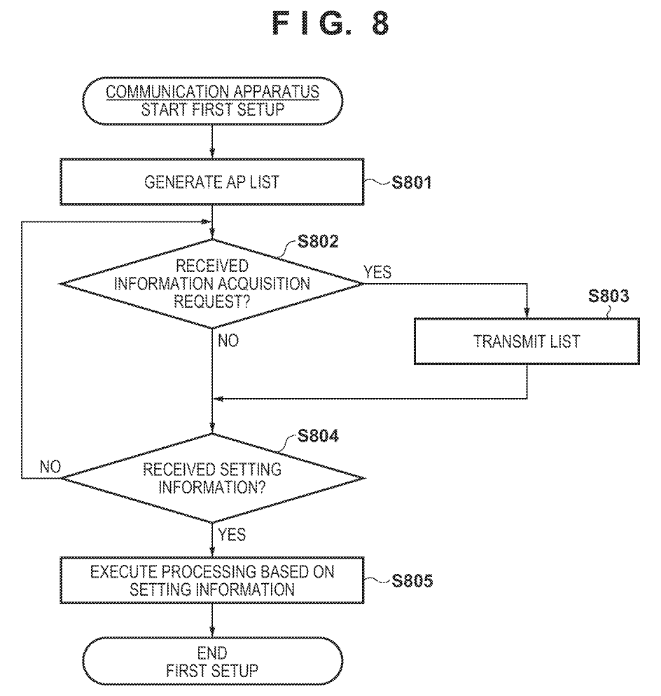

FIG. 8 is a flowchart illustrating the first setup executed by the communication apparatus 151. This flowchart is implemented when the CPU 154 reads out the program stored in the ROM 152 into the RAM 153 and executes it. This flowchart is started based on that the communication apparatus 151 accepts a user operation for operating in the connection setting mode.

In step S801, the CPU 154 searches for APs existing around the communication apparatus 151, and generates a list of the discovered APs.

In step S802, the CPU 154 determines whether an information acquisition request is received from the terminal apparatus 101. If YES is determined, the CPU 154 advances to step S803. If NO is determined, the CPU 154 advances to step S804.

Note that instead of executing step S801 before step S802, step S801 may be executed after YES is determined in step S802.

In step S803, the CPU 154 transmits the list generated in step S801 to the terminal apparatus 101.

In step S804, the CPU 154 determines whether setting information is received from the terminal apparatus 101. If YES is determined, the CPU 154 advances to step S805. If NO is determined, the CPU 154 returns to step S802.

In step S805, the CPU 154 executes the network setup based on the received setting information. More specifically, the CPU 154 establishes a connection between the communication apparatus 151 and the AP corresponding to the connection information included in the received setting information by using the connection information included in the received setting information. After that, the processing of this flowchart ends.

According to this embodiment, the setup application causes the CPU 103 of the terminal apparatus 101 to operate as follows. The CPU 103 uses the confirmation screen 610 to make the user confirm whether the AP 131 exists around the communication apparatus 151. Then, based on the user operation on the confirmation screen 610, the CPU 103 switches whether to execute the first setup. This configuration can prevent the first setup from being executed and failing in a case where the AP 131 does not exist around the communication apparatus 151. On the other hand, in a case where the AP 131 exists around the communication apparatus 151, the first setup is executed. This can improve convenience when the terminal apparatus 101 causes the communication apparatus 151 to connect to the AP 131.

### Second Embodiment

The second embodiment will be described below concerning differences from the first embodiment. In the first embodiment, if NO is determined to execute the first setup as a result of the second determination processing, the CPU 103 displays the selection screen 1010 again. In this embodiment, if NO is determined to execute the first setup as a result of the second determination processing, a CPU 103 confirms whether to establish a direct connection between a terminal apparatus 101 and a communication apparatus 151. If it is confirmed to establish the direct connection, the CPU 103 executes the fifth setup for establishing the direct connection (to be described later). That is, in this embodiment, if an AP 131 does not exist around the communication apparatus 151, a setup application causes the terminal apparatus 101 to execute the fifth setup instead of the first setup, thereby establishing a connection via wireless LAN communication. With this, in a case where the user selects a wireless LAN connection method as the connection method between the terminal apparatus 101 and the communication apparatus 151, the setup application can guide the user to an appropriate setup method depending on whether the AP 131 exists around the communication apparatus 151.

In this embodiment, the CPU 103 can execute the fifth setup for setting the communication apparatus 151 in a direct connection mode via the wireless connection between the terminal apparatus 101 and the communication apparatus 151 operating in a connection setting mode. The fifth setup is a setup method in which the communication apparatus 151 is caused to operate in the direct connection mode by transmitting an instruction to set the direct connection mode from the terminal apparatus 101 to the communication apparatus 151 via wireless communication, thereby directly connecting the terminal apparatus 101 and the communication apparatus 151 operating in the direct connection mode.

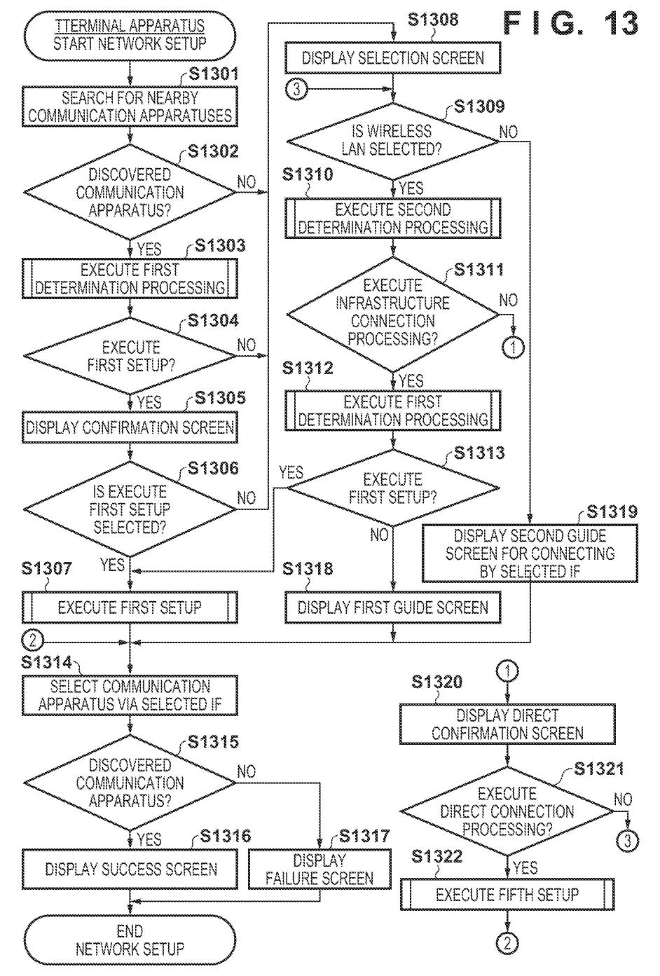

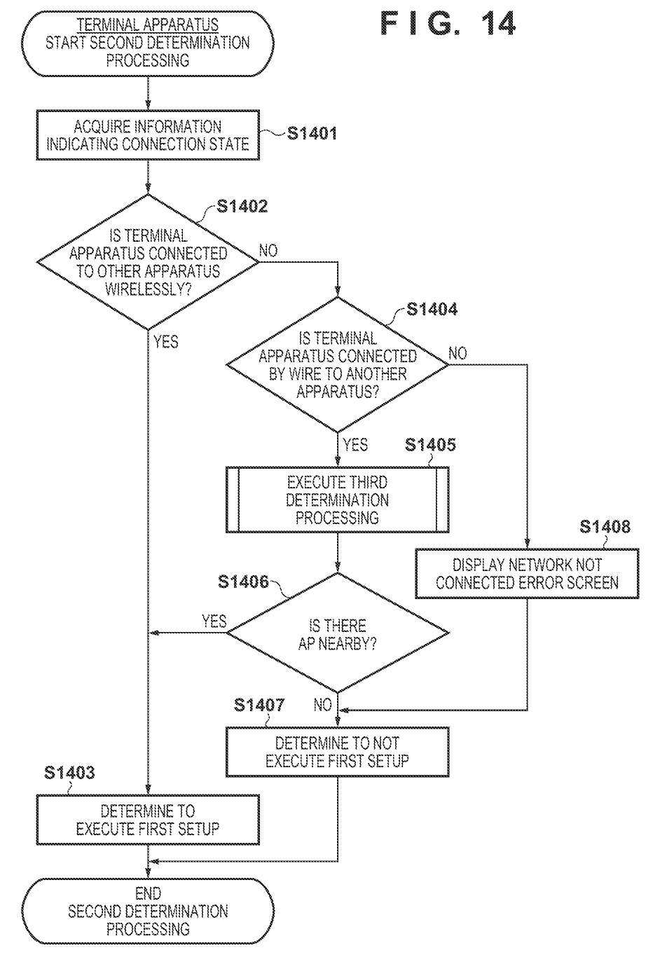

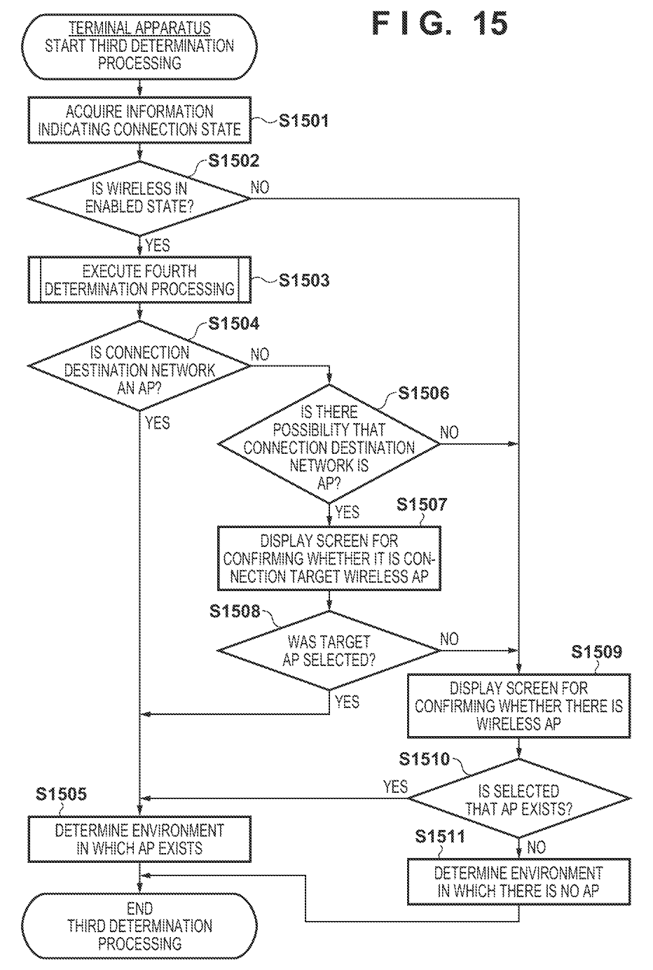

FIG. 13 is a flowchart illustrating the network setup of the communication apparatus 151, which is executed by the terminal apparatus 101. This flowchart is implemented when the CPU 103 reads out the program stored in a ROM 104 into a RAM 105 and executes it. Note that in this embodiment, the terminal apparatus 101 executes the processing using the setup application. This flowchart is started based on that the user made the above-described predetermined instruction on a screen displayed by the setup application.

Steps S1301 to S1310 are similar to steps S301 to S310, so that a description thereof will be omitted.

In step S1311, the CPU 103 determines whether it is determined to execute the first setup in the second determination processing. If YES is determined, the CPU 103 advances to step S1312. If NO is determined, the CPU 103 advances to step S1320.

In the first embodiment, if NO is determined in step S311, the CPU 103 advances to step S308 and displays the selection screen 1010 again on the display unit 108. In this embodiment, if the first setup is not executed (if NO is determined in step S1311), the CPU 103 advances to step S1320 and executes processing for directly connecting the terminal apparatus 101 and the communication apparatus 151 via a wireless LAN. Here, the processing to be executed when the CPU 103 determines NO in step S1311 will be described.

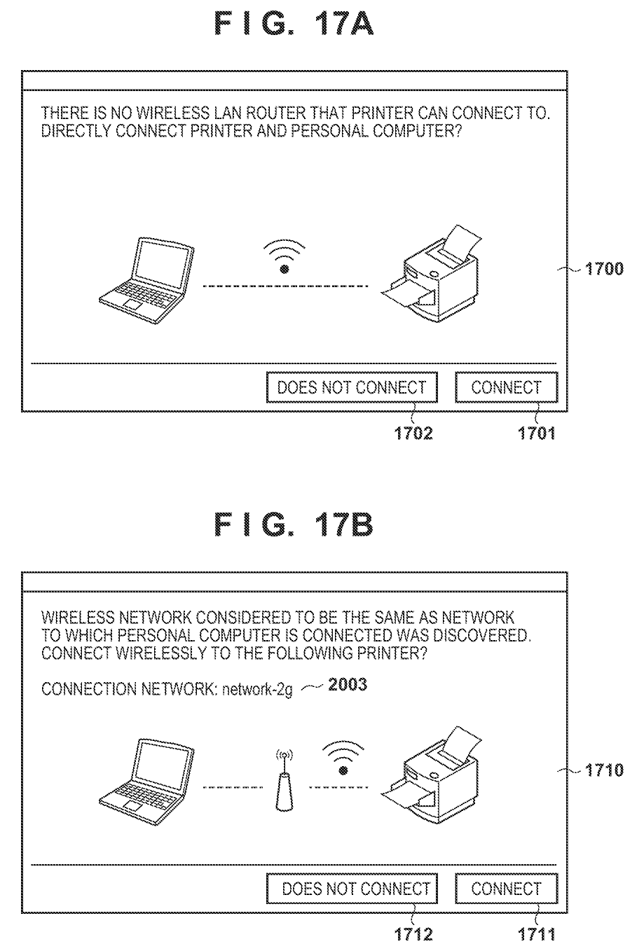

In step S1320, the CPU 103 displays, on a display unit 108, a direct confirmation screen for confirming whether to execute direct connection. Here, for example, a direct confirmation screen 1700 shown in FIG. 17A is displayed. For example, the direct confirmation screen 1700 includes a button 1701 for selecting to execute direct connection, and a button 1702 for selecting not to execute direct connection. That is, the direct confirmation screen 1700 can also be considered an acceptance screen that can accept a user selection as to whether to execute direct connection.

The direct confirmation screen 1700 displays a message indicating that the AP 131 to which the communication apparatus 151 can connect via a wireless LAN does not exist nearby. The direct confirmation screen 1700 also displays a message prompting the user to confirm whether to establish direct connection between the communication apparatus 151 and the terminal apparatus 101.

In step S1321, the CPU 103 determines whether an operation corresponding to executing direct connection is performed on the direct confirmation screen 1700. More specifically, in this determination, the CPU 103 determines YES if the button 1701 is selected, and determines NO if the button 1702 is selected. If YES is determined, the CPU 103 advances to step S1322. If NO is determined, the CPU 103 returns to step S1309.

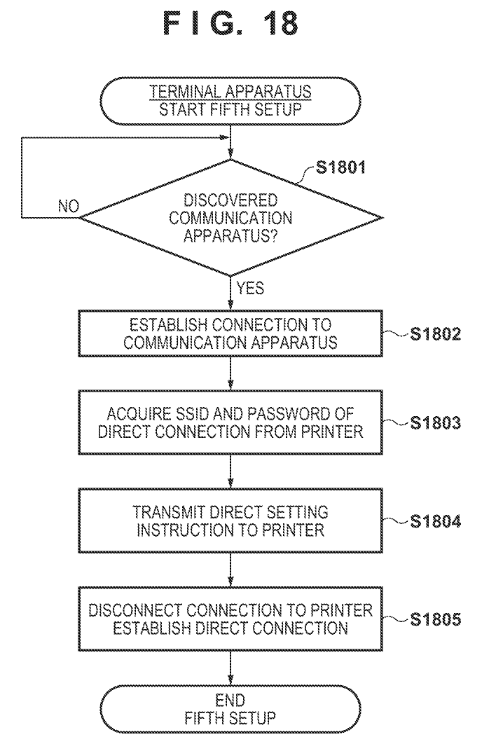

In step S1322, the CPU 103 executes the fifth setup. Details of this processing will be described later with reference to FIG. 18. After that, the CPU 103 advances to step S1314.

Note that the processing in steps S1312 to S1314 are similar to the processing in steps S312 to S314, and step S1316 to S1319 are similar to steps S316 to S319, so that a description thereof will be omitted.

In step S1315, the CPU 103 determines whether the communication apparatus 151 has been discovered through the search in step S1314. If YES is determined, the CPU 103 advances to step S1316. If NO is determined, the CPU 103 advances to step S1317. Note that in a case where this processing is executed after the fifth setup, the CPU 103 specifies whether the communication apparatus 151 having established the connection by the fifth setup is included in one or multiple apparatuses discovered through the search in step S1314. If it is specified that the communication apparatus 151 is included, the CPU 103 determines YES in this determination. That is, if no apparatus is discovered through the search in step S1314, or if the communication apparatus 151 having established the connection by the fifth setup is not included in one or multiple discovered apparatuses, the CPU 103 determines NO in this determination. Note that the CPU 103 may determine based on whether the connection between the communication apparatus 151 and the terminal apparatus 101 is successfully established by the fifth setup. More specifically, if the connection between the communication apparatus 151 and the terminal apparatus 101 is successfully established by the fifth setup, YES is determined in this determination. Furthermore, if the connection between the communication apparatus 151 and the terminal apparatus 101 fails by the fifth setup, NO is determined in this determination. The state where the connection between the communication apparatus 151 and the terminal apparatus 101 is successfully established is a state where the terminal apparatus 101 is connected to the direct connection SSID issued by the communication apparatus 151.

FIG. 18 is a flowchart illustrating the fifth setup executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to the processing in step S1322.

In step S1801, the CPU 103 searches for the communication apparatus 151 operating in the connection setting mode. Then, it is determined whether the communication apparatus 151 operating in the connection setting mode is discovered. This processing is performed similarly to the processing in steps S301 and S302, so that a detailed description will be omitted. If YES is determined, the CPU 103 advances to step S1802. If NO is determined, the CPU 103 returns to step S1801 and repeats the search. Note that if the communication apparatus 151 operating in the connection setting mode has been already discovered in step S1302, this processing may be omitted.

In step S1802, the CPU 103 establishes a wireless connection between the terminal apparatus 101 and the communication apparatus 151 operating in the connection setting mode. That is, in step S1802, a direct wireless connection is established between the terminal apparatus 101 and the communication apparatus operating in the connection setting mode.

In step S1803, the CPU 103 transmits an acquisition request for the direct connection information to the communication apparatus 151. Then, the CPU 103 receives, from the communication apparatus 151, the direct connection information in response to the acquisition request, thereby acquiring the direct connection information. The direct connection information is connection information (including the SSID and the password) for directly connecting to the communication apparatus 151 in a case where the communication apparatus 151 operates in the direct connection mode.

In step S1804, the CPU 103 transmits, to the communication apparatus 151, a direct setting instruction to set the communication apparatus 151 in the direct connection mode. That is, the CPU 103 instructs the communication apparatus 151 to operate in the direct connection mode.

In step S1805, the CPU 103 connects to the SSID included in the direct connection information acquired in step S1803, thereby establishing a direct connection to the communication apparatus 151 operating in the direct connection mode. After that, the processing of this flowchart is terminated.

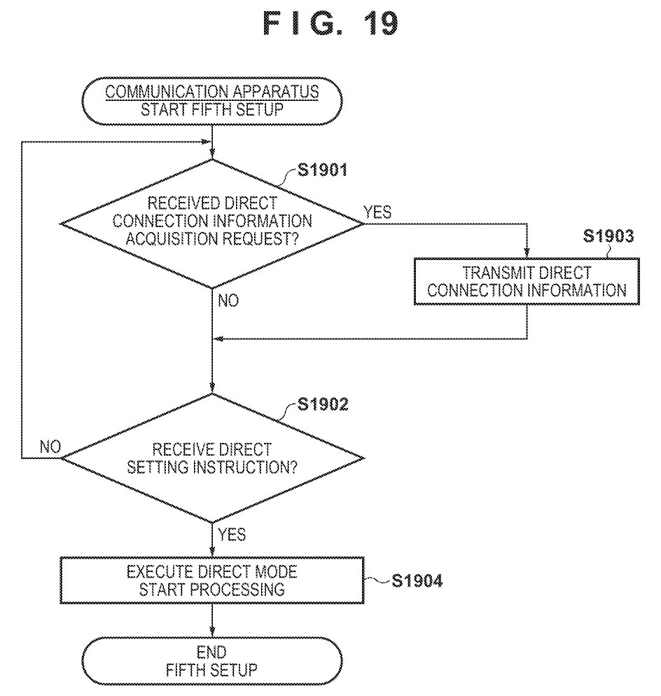

FIG. 19 is a flowchart illustrating the fifth setup executed by the communication apparatus 151. This flowchart is implemented when a CPU 154 reads out the program stored in a ROM 152 into a RAM 153 and executes it. This flowchart is started based on that the communication apparatus 151 accepts a user operation for operating in the connection setting mode.

In step S1901, the CPU 154 determines whether an acquisition request for the direct connection information is received from the terminal apparatus 101. If YES is determined, the CPU 154 advances to step S1903. If NO is determined, the CPU 154 advances to step S1902.

In step S1903, the CPU 154 transmits the direct connection information (SSID and password) to the terminal apparatus 101.

In step S1902, the CPU 154 determines whether a direct setting instruction is received from the terminal apparatus 101. If YES is determined, the CPU 154 advances to step S1904. If NO is determined, the CPU 154 returns to step S1901.

In step S1904, the CPU 154 sets the direct connection mode based on the received direct setting instruction. More specifically, the communication apparatus 151 changes from the connection setting mode to the direct connection mode, and terminates the fifth setup processing. More specifically, the communication apparatus 151 terminates the connection setting mode, thereby disabling an AP 156-a having the SSID corresponding to the connection setting mode. After that, the communication apparatus 151 starts the direct connection mode, thereby enabling the AP 156-a having the direct connection SSID. With this, the terminal apparatus 101 can connect to the direct connection SSID issued by the communication apparatus 151. After that, the processing of this flowchart ends.

According to this embodiment, the setup application causes the CPU 103 to operate as follows. If the AP 131 does not exist around the communication apparatus 151, the CPU 103 causes the terminal apparatus 101 to execute the fifth setup instead of the first setup. By the fifth setup, a direct connection via wireless LAN communication is established between the terminal apparatus 101 and the communication apparatus 151. With this configuration, in a case where the user selects a wireless LAN connection method as the connection method between the terminal apparatus 101 and the communication apparatus 151, it is possible to guide the user to an appropriate setup method depending on whether the AP 131 exists around the communication apparatus 151.

### Third Embodiment

The third embodiment will be described below concerning differences from the first embodiment and the second embodiment. In the embodiments described above, the setup application causes the CPU 103 to operate as follows. In the second determination processing, as predetermined processing for confirming (specifying) whether the AP 131 exists nearby, the CPU 103 displays the confirmation screen 610. The CPU 103 accepts a selection operation on the confirmation screen 610 from the user as to whether a wireless LAN router exists around the terminal apparatus 101, thereby confirming whether the AP 131 exists nearby. In this embodiment, in the second determination processing, as predetermined processing for confirming whether an AP 131 exists nearby, a CPU 103 executes processing of automatically determining based on information concerning the network connected to a terminal apparatus 101, without accepting the above-described selection operation on a confirmation screen 610 from the user. This configuration can reduce the situations where the user needs to determine whether the AP 131 exists nearby, and can further improve convenience in setup of a communication apparatus 151.

FIG. 14 is a flowchart illustrating the second determination processing executed by the terminal apparatus 101 according to this embodiment. This flowchart is implemented when the CPU 103 reads out the program stored in a ROM 104 into a RAM 105 and executes it. Note that in this embodiment, the terminal apparatus 101 executes the processing using the setup application. In this embodiment, the setup application executes the second determination processing of FIG. 14 in step S310. Note that the setup application may execute the second determination processing of FIG. 14 in step S1310.

Steps S1401 to S1403 are similar to steps S501 to S503, so that a detailed description thereof will be omitted.

In step S1404, based on the information indicating the connection state of a wired communication unit 112 acquired in step S1401, the CPU 103 determines whether the terminal apparatus 101 is connected to another apparatus via a wired LAN. If YES is determined, the CPU 103 advances to step S1405. If NO is determined, the CPU 103 advances to step S1408.

In the first embodiment, if it is determined in step S504 that the terminal apparatus 101 is connected to another apparatus via a wired LAN, the CPU 103 advances to step S505 and displays the confirmation screen 610. In the second embodiment, the processing similar to the processing in the first embodiment is executed. On the other hand, in this embodiment, if YES is determined, the CPU 103 advances to step S1405 and executes the third determination processing to be described later.

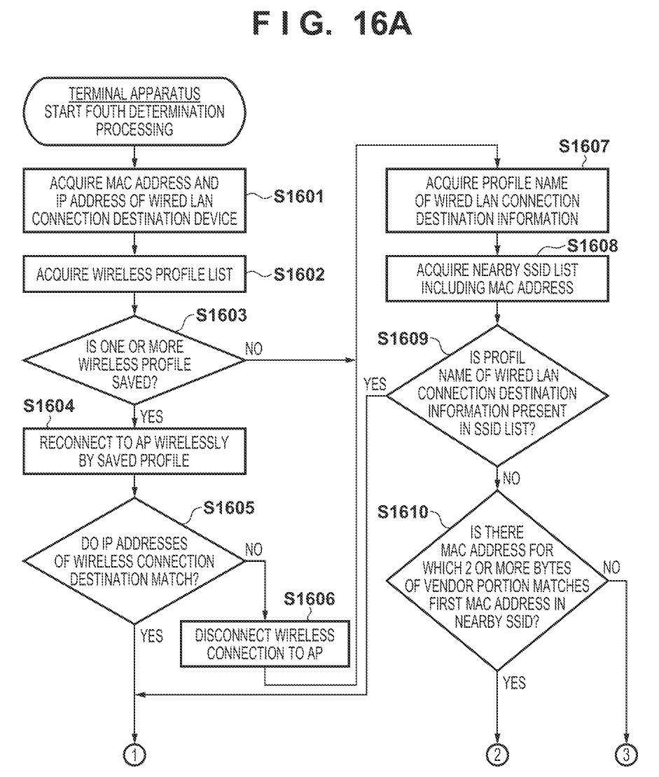

In step S1405, the CPU 103 executes the third determination processing for determining whether the AP 131 exists nearby. Details of the third determination processing will be described later with reference to FIG. 15.

In step S1406, the CPU 103 determines whether it is determined that the AP 131 exists nearby in the third determination processing. If YES is determined, the CPU 103 advances to step S1403. If NO is determined, the CPU 103 advances to step S1407.

The processing in steps S1407 and S1408 is similar to the processing in steps S507 and S508, so that a description thereof will be omitted.

FIG. 15 is a flowchart illustrating the third determination processing executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to the processing in step S1405.

In step S1501, the CPU 103 acquires information indicating the connection state of the terminal apparatus 101 from the OS of the terminal apparatus 101 by using the API of the OS. More specifically, in step S1501, as information indicating the connection state of the terminal apparatus 101, the CPU 103 acquires information indicating the connection state of a wireless communication unit 109 from the OS.

In step S1502, based on the information indicating the connection state of the wireless communication unit 109 acquired in step S1501, the CPU 103 determines whether the wireless communication unit 109 of the terminal apparatus 101 is in an enabled state. In other words, the enabled state of the wireless communication unit 109 is a state in which the wireless communication unit 109 of the terminal apparatus 101 is able to communicate. That is, the CPU 103 determines whether the wireless communication function of the terminal apparatus 101 for communicating with another apparatus via a wireless LAN is enabled. If YES is determined, the CPU 103 advances to step S1503. If NO is determined, the CPU 103 advances to step S1509.

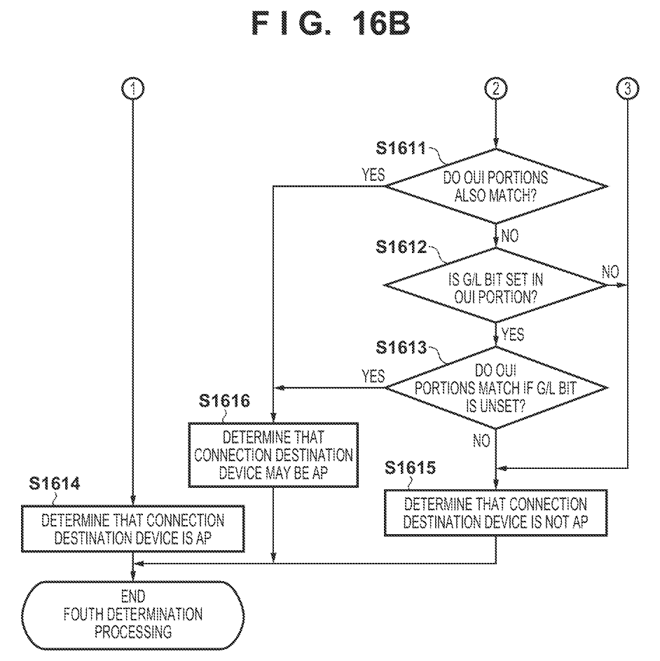

In step S1503, the CPU 103 executes the fourth determination processing for determining whether another apparatus connected to the terminal apparatus 101 is the AP 131. Details of the fourth determination processing will be described later with reference to FIGS. 16A and 16B. In the following description, another apparatus connected to the terminal apparatus 101 may be referred to as a network device.

In step S1504, the CPU 103 determines whether the network device connected to the terminal apparatus 101 is the AP 131 in the fourth determination processing. That is, if it is determined in step S1614 of the fourth determination processing of FIG. 16B (to be described later) that the connected device is the AP 131, the CPU 103 determines YES. If YES is determined, the CPU 103 advances to step S1505. If NO is determined, the CPU 103 advances to step S1506.

In step S1505, the CPU 103 determines that it is the environment where the AP 131 exists nearby. This determination result is referred to in step S1406. After step S1505, the CPU 103 terminates the processing of this flowchart.

In step S1506, the CPU 103 determines whether the network device connected to the terminal apparatus 101 via the wired LAN is likely to be the AP 131. That is, if it is determined in step S1616 of the fourth determination processing of FIG. 16B (to be described later) that the connected network device is likely to be the AP 131, the CPU 103 determines YES. If YES is determined, the CPU 103 advances to step S1507. If NO is determined, the CPU 103 advances to step S1509.

In step S1507, the CPU 103 executes the processing of prompting the user to confirm whether the network device connected to the terminal apparatus 101 via the wired LAN is the AP 131 to be set in the communication apparatus 151. In step S1507, the CPU 103 displays, for example, a confirmation screen 1710 shown in FIG. 17B on a display unit 108.

A region 2003 showing the SSID of the network device connected to the terminal apparatus 101, which is determined to be likely the AP 131 in the fourth determination processing, is displayed on the confirmation screen 1710. The confirmation screen 1710 also displays a button 1711 that can accept a user selection corresponding to continuing the connection processing with the AP displayed in the region 2003, and a button 1712 that can accept a user operation corresponding to not continuing the connection processing with the AP displayed in the region 2003. The confirmation screen 1710 also displays a message prompting the user to confirm whether to connect the communication apparatus 151 to the AP. The confirmation screen 1710 also displays a message prompting the user to select whether to connect the communication apparatus 151 to the wireless network estimated to be identical to the wireless network connected to the terminal apparatus 101. By displaying the screen 1710 as described above, it is possible to prompt the user to confirm whether the network device connected to the terminal apparatus 101 via the wired LAN is the AP 131 to be set in the communication apparatus 151.

In step S1508, the CPU 103 determines whether it is selected to continue connection to the AP on the confirmation screen 1710. More specifically, in this determination, the CPU 103 determines YES if the button 1711 is selected, and determines NO if the button 1712 is selected. If YES is determined, the CPU 103 advances to step S1505. If NO is determined, the CPU 103 advances to step S1509.

In step S1509, the CPU 103 displays, on the display unit 108, a confirmation screen for confirming whether the AP 131 exists nearby. Here, for example, the confirmation screen 610 shown in FIG. 6B is displayed. That is, in this embodiment, the processing of automatically determining based on the information concerning the network connected to the terminal apparatus 101 is executed without accepting a selection operation on the confirmation screen 610 from the user. However, in a case where the processing advances up to step S1509, the processing of accepting a selection operation on the confirmation screen 610 from the user may be executed.

In step S1510, the CPU 103 determines whether it is selected on the confirmation screen 610 that the AP 131 exists nearby. More specifically, in this determination, the CPU 103 determines YES if a button 611 is selected, and determines NO if a button 612 is selected. If YES is determined, the CPU 103 advances to step S1505. If NO is determined, the CPU 103 advances to step S1511.

In step S1511, the CPU 103 determines that it is the environment where the AP 131 does not exist nearby. This determination result is referred to in step S1406. After step S1511, the CPU 103 terminates the processing of this flowchart.

FIGS. 16A and 16B are flowcharts illustrating the fourth determination processing executed by the terminal apparatus 101. This flowchart is implemented when the CPU 103 reads out the program stored in the ROM 104 into the RAM 105 and executes it. Note that in this embodiment, the terminal apparatus 101 executes the processing using the setup application. This flowchart corresponds to the processing in step S1503.

In step S1601, the CPU 103 acquires the information of the connection destination of the wired communication unit 112 from the OS of the terminal apparatus 101 by using the API of the OS. The information of the connection destination of the wired communication unit 112 corresponds to the information concerning the network connected to the terminal apparatus 101. More specifically, the information of the connection destination of the wired communication unit 112 includes the MAC address (to be referred to as the first MAC address hereinafter) of the device connected to the wired communication unit 112, and the IP address (to be referred to as the first IP address hereinafter) thereof. That is, the CPU 103 acquires the information (the first MAC address and the first IP address) concerning the network device connected to the terminal apparatus 101 via the wired LAN.

In step S1602, the CPU 103 acquires a wireless profile list held by the terminal apparatus 101 from the OS of the terminal apparatus 101.

In step S1603, the CPU 103 determines whether one or more wireless profiles are included in the wireless profile list acquired in step S1602. That is, the CPU 103 determines whether one or more wireless profiles can be acquired in step S1602. If YES is determined, the CPU 103 advances to step S1604. If NO is determined, the CPU 103 advances to step S1607.

In step S1604, the CPU 103 uses a wireless profile held by the OS to establish a connection between the terminal apparatus 101 and the AP corresponding to a wireless profile acquired in step S1602.

In step S1605, the CPU 103 compares the IP address of the connected AP with which the connection is established in step S1604 and the first IP address acquired in step S1601, and determines whether these IP addresses match. If YES is determined, the CPU 103 advances to step S1614. If NO is determined, the CPU 103 advances to step S1606.

Note that if multiple wireless profiles are acquired in step S1602, the CPU 103 may execute the processing in steps S1604 and S1605 for each wireless profile. If NO is determined in step S1605, the CPU 103 executes step S1604 with respect to another wireless profile included in the wireless profile list. If YES is determined in step S1605, the CPU 103 may advance to step S1614 even if another wireless profile is also included in the wireless profile list.

In step S1606, the CPU 103 disconnects the connection between the AP 131 and the terminal apparatus 101 established in step S1604.

In step S1607, the CPU 103 acquires the information of the connection destination of the wired communication unit 112 from the OS of the terminal apparatus 101. More specifically, as connection information of the wired communication unit 112, the CPU 103 acquires the wired profile name held by the OS. As described above, the wired profile name is the network name saved in a wired profile by the OS. For example, if the terminal apparatus 101 has connected to the AP 131 via a wireless LAN, the OS saves, as the wired profile name, the SSID of the AP serving as the network name of the wireless LAN. Accordingly, if the terminal apparatus 101 has connected to the AP via a wireless LAN, the CPU 103 acquires the wired profile name that matches the SSID of the AP 131.

In step S1608, the CPU 103 searches for APs existing around the terminal apparatus 101, and generates a list of discovered APs. The list of discovered APs includes the information (MAC address) that can uniquely identify each AP, and the network name (SSID) of the AP.

In step S1609, the CPU 103 determines whether the wired profile name acquired in step S1607 is included in the AP list acquired in step S1608. If YES is determined, the CPU 103 advances to step S1614. If NO is determined, the CPU 103 advances to step S1610.

If there is the AP matching the wired profile name, it can be estimated that the network device connected to the terminal apparatus 101 via the wired LAN is the AP 131. Hence, if YES is determined in step S1609, the CPU 103 advances the process to step S1614.

On the other hand, if there is no AP matching the wired profile name, it cannot be determined whether the network device connected to the terminal apparatus 101 via the wired LAN is the AP 131. Hence, if there is no AP matching the wired profile name, the CPU 103 determines, based on the MAC address of the AP discovered in step S1608, whether the network device connected to the terminal apparatus 101 via the wired LAN is likely to be the AP 131. Different MAC addresses are assigned to the wireless LAN and the wired LAN, respectively. For example, the vender of each network device may assign different MAC addresses using a method of changing the vender management portion of the MAC address or setting the G/L bit in the OUI portion. In this embodiment, if the MAC address having the same OUI portion and similar vender management portion is included in the AP list, it is considered that the network device connected to the terminal apparatus 101 via the wired LAN is likely to be the AP 131.

In step S1610, the CPU 103 compares the MAC address included in the AP list acquired in step S1608 with the first MAC address acquired in step S1601. Then, the CPU 103 determines whether the MAC address having three least significant bytes similar to those of the first MAC address is included in the AP list acquired in step S1608. More specifically, the CPU 103 compares the vender management portion of the MAC address of the AP acquired in step S1608 with the vender management portion of the first MAC address. Then, the CPU 103 determines whether the MAC address included in the AP list acquired in step S1608 matches the first MAC address in at least two bytes or more. If the MAC address matches the first MAC address in at least two bytes or more, the CPU 103 considers that a similar MAC address is included. If YES is determined, the CPU 103 advances to step S1611. If NO is determined, the CPU 103 advances to step S1615.

In step S1611, the CPU 103 compares the OUI portion of the first MAC address acquired in step S1601 with the OUI portion of the MAC address of the AP included in the AP list acquired in step S1608 and determined to be similar in step S1610. The MAC address of the AP included in the AP list acquired in step S1608 and determined to be similar in step S1610 may be referred to as the second MAC address. Then, CPU 103 determines whether these OUI portions match. In this manner, the CPU 103 determines whether the OUI portion of the first MAC address and the OUI portion of the second MAC address match, thereby confirming whether the network device connected to the terminal apparatus 101 via the wired LAN is likely to be the AP 131. If YES is determined, the CPU 103 advances to step S1616. If NO is determined, the CPU 103 advances to step S1612.

In step S1612, the CPU 103 determines whether the G/L bit is set in at least one of the OUI portion of the first MAC address and the OUI portion of the second MAC address. If the G/L bit is set in either of the OUI portions, the CPU 103 determines YES. If the G/L bit is not set in both OUI portions, the CPU 103 determines NO. If YES is determined, the CPU 103 advances to step S1613. If NO is determined, the CPU 103 advances to step S1615.

In step S1613, the CPU 103 unsets the G/L bit of the MAC address, which is determined to have the G/L bit set in step S1612, and determines whether the OUI portion of the first MAC address matches the OUI portion of the second MAC address. If YES is determined, the CPU 103 advances to step S1616. If NO is determined, the CPU 103 advances to step S1615.

In step S1614, the CPU 103 determines that another apparatus connected to the terminal apparatus 101 via the wired LAN is the AP 131. This determination result is referred to in step S1504. After step S1614, the CPU 103 terminates the processing of this flowchart.

In step S1615, the CPU 103 determines that another apparatus connected to the terminal apparatus 101 via the wired LAN is not the AP 131. This determination result is referred to in steps S1504 and S1506. After step S1615, the CPU 103 terminates the processing of this flowchart.

In step S1616, the CPU 103 determines that the network device connected to the terminal apparatus 101 is likely to be the AP 131. This determination result is referred to in steps S1504 and S1506. After step S1616, the CPU 103 terminates the processing of this flowchart.

According to this embodiment, the setup application causes the CPU 103 to operate as follows. Based on the information of the network device connected to the terminal apparatus 101 via a wired LAN, the CPU 103 determines whether the AP 131 to be desirably connected to the communication apparatus 151 exists nearby. This configuration can omit the procedure of prompting the user to confirm whether the AP 131 exists nearby. Thus, user convenience can be further improved as compared to the second determination processing in the first and second embodiments.

### Modifications

In the above description, if the region 1011 is selected, depending on the results of the second determination processing and the first determination processing, it is controlled to execute the first setup or display the guide screen for the second setup. However, the present disclosure is not limited to this form. If the region 1011 is selected, the guide screen for the second setup may be displayed without executing the first determination processing. That is, if YES is determined in step S309 and YES in step S311, step S318 may be executed without executing steps S312 and S313.

In the above description, the first determination processing includes both the determination in step S406 and the determination in step S407, but only one of them may be included. That is, for example, in a case where only the determination in step S406 is included, if YES is determined in step S405, or if NO is determined in step S406, step S408 may be executed without executing step S407. In a case where only the determination in step S407 is included, if NO is determined in step S405, step S409 may be executed without executing step S406.

The form has been described above in which the processing executed if NO is determined to execute the first setup in the second determination processing is the processing of displaying the selection screen 1010 including an option corresponding to the third setup. However, the present disclosure is not limited to this form. If NO is determined to execute the first setup in the second determination processing, the guide screen for the third setup may be displayed without displaying the selection screen 1010. Alternatively, options included in the selection screen 1010 other than the option corresponding to the third setup may be hidden, or options included in the selection screen 1010 other than the option corresponding to the third setup may be set in an unselectable state.

In the above description, in the first setup, the terminal apparatus 101 uses the wireless communication unit 109 to transmit the setting information to the communication apparatus 151. However, the present disclosure is not limited to this form. The terminal apparatus 101 may use the short distance wireless communication unit 110 to transmit the setting information to the communication apparatus 151. That is, the setting information may be transmitted via short distance wireless communication such as BLE or Bluetooth between the terminal apparatus 101 and the communication apparatus 151. In this form, the wireless LAN connection between the terminal apparatus 101 and the AP 131 need not be disconnected in step S702. That is, the terminal apparatus 101 may use the short distance wireless communication unit 110 to transmit the setting information to the communication apparatus 151 while maintaining the wireless LAN connection between the terminal apparatus 101 and the AP 131.

In the above description, the form has been described in which if NO is determined in step S315, the failure screen 1030 is displayed, and the processing is terminated when the end button 1031 is pressed. However, the present disclosure is not limited to this form. A button (not shown) to restart the flowchart of FIG. 3 from the beginning may be arranged in the failure screen 1030. Alternatively, a connection method reselection button (not shown) to transition to step S308 may be arranged in the failure screen 1030. For example, by pressing the connection method reselection button (not shown) on the failure screen 1030, the user can immediately select the fourth setup in a case where the first setup, the second setup, and the third setup fail.

The form as follows has been described above as an example of displaying the selection screen 1010 in step S308. If the communication apparatus 151 could not be discovered (NO is determined in step S302), the CPU 103 displays the selection screen 1010. If the communication apparatus 151 has been discovered (YES is determined in step S302) and if NO is determined to execute the first setup (NO is determined in step S309), the CPU 103 displays the selection screen 1010. Furthermore, if it is determined that it is not selected to execute the first setup on the confirmation screen 600 (NO is determined in step S306), the CPU 103 displays the selection screen 1010. However, the present disclosure is not limited to these forms, and the CPU 103 may display the selection screen 1010 as follows. For example, if it is determined that the communication apparatus 151 has been discovered in step S302, the CPU 103 may advance to step S308 and display the selection screen 1010. In this form, if it is determined in step S302 that the communication apparatus 151 has not been discovered, for example, the CPU 103 may repeat the processing in step S302. Alternatively, for example, if it is determined in step S302 that the communication apparatus 151 has not been discovered, a notification prompting the user to operate the communication apparatus 151 to cause the communication apparatus 151 to operate in the connection setting mode. After that, the CPU 103 may execute the processing in step S302 again.

According to the present disclosure, it is possible to improve convenience when an information processing apparatus causes a communication apparatus to connect to another apparatus.

It is needless to say that the present disclosure is achieved by supplying a storage medium which stores software program codes for implementing the functions of the above-described embodiment to a system or an apparatus, and the computer (CPU or MPU) of the system or the apparatus reading out and executing the programs codes stored in the storage medium. In this case, the program codes read out from the storage medium implement the functions of the above-described embodiment by themselves, and the storage medium which stores the program codes constitutes the embodiment.

As the storage medium for supplying the program codes, for example, a flexible disk, a hard disk, an optical disk, a magneto-optical disk, a CD-ROM, a CD-R, a magnetic tape, a nonvolatile memory card, a ROM, a DVD, or the like can be used.

It is also needless to say that the functions of the above-described embodiment are implemented not only when the readout program codes are executed by the computer but also when the operating system (OS) running on the computer performs a part or all of actual processing on the basis of the instructions of the program codes.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176738, filed October 8, 2024 which is hereby incorporated by reference herein in its entirety.

WHAT IS CLAIMED IS:

1. A non-transitory computer-readable storage medium storing an application program configured to cause a computer of an information processing apparatus to function as:
a first display unit configured to display a selection screen for selecting any connection method of connecting a communication apparatus to another apparatus;
a second display unit configured to, in a case where a selection corresponding to connecting the communication apparatus to another apparatus by a first connection method using a wireless Local Area Network (LAN) is performed on the selection screen, display a confirmation screen for prompting a user to confirm whether an apparatus operating as an access point exists around the communication apparatus; and
an execution unit configured to execute connection setting processing for connecting the communication apparatus to another apparatus by the first connection method in a case where an operation corresponding to confirming that an apparatus operating as an access point exists around the communication apparatus is performed on the confirmation screen, and not to execute the connection setting processing in a case where an operation corresponding to confirming that an apparatus operating as an access point does not exist around the communication apparatus is performed on the confirmation screen.

2. The medium according to claim 1, wherein
the computer is caused to further function as
a first determination unit configured to, in a case where a selection corresponding to connecting the communication apparatus to another apparatus by the first connection method is performed on the selection screen, determine whether the information processing apparatus is connected to another apparatus via a wireless LAN, and
in a case where the first determination unit determines that the information processing apparatus is connected to another apparatus via a wireless LAN, the execution unit executes the connection setting processing without causing the second display unit to display the confirmation screen.

3. The medium according to claim 2, wherein
the computer is caused to further function as
a second determination unit configured to, in a case where the first determination unit determines that the information processing apparatus is not connected to another apparatus via a wireless LAN, determine whether the information processing apparatus is connected to another apparatus via a wired LAN, and
the execution unit
causes the second display unit to display the confirmation screen in a case where the second determination unit determines that the information processing apparatus is connected to another apparatus via a wired LAN, and
does not execute the connection setting processing without causing the second display unit to display the confirmation screen in a case where the second determination unit determines that the information processing apparatus is not connected to another apparatus via a wired LAN.

4. The medium according to claim 3, wherein
the computer is caused to further function as
a notification unit configured to, in a case where the second determination unit determines that the information processing apparatus is not connected to another apparatus via a wired LAN, notify that the information processing apparatus is not connected to an external network.

5. The medium according to claim 1, wherein
in a case where the connection setting processing is not executed, the execution unit causes the first display unit to display the selection screen again.

6. The medium according to claim 1, wherein
in a case where the connection setting processing is not executed, the execution unit executes processing for directly connecting the information processing apparatus and the communication apparatus via a wireless LAN.

7. The medium according to claim 1, wherein
the connection setting processing is processing for transmitting, to the communication apparatus, information for connection to an apparatus operating as an access point.

8. The medium according to claim 7, wherein
the information includes an SSID of an apparatus operating as the access point, and a password.

9. The medium according to claim 7, wherein
the information is transmitted from the information processing apparatus to the communication apparatus using a wireless LAN.

10. The medium according to claim 7, wherein
the information is transmitted from the information processing apparatus to the communication apparatus using short distance wireless communication.

11. The medium according to claim 1, wherein
the computer is caused to further function as
a search unit configured to search for the communication apparatus operating as a predetermined access point, and
in a case where the search unit has discovered the communication apparatus operating as the predetermined access point, the first display unit displays the selection screen.

12. The medium according to claim 1, wherein
the selection screen is a screen that can accept one of a selection corresponding to connecting the communication apparatus to another apparatus by the first connection method, and a selection corresponding to connecting the communication apparatus to another apparatus by a second connection method using a wired LAN.

13. The medium according to claim 1, wherein
the selection screen is a screen that can accept one of a selection corresponding to connecting the communication apparatus to another apparatus by the first connection method, and a selection corresponding to connecting the communication apparatus to the information processing apparatus by a third connection method using USB.

14. The medium according to claim 1, wherein
the confirmation screen displays information prompting a user to confirm whether an apparatus operating as an access point exists around the communication apparatus.

15. The medium according to claim 1, wherein
in a case where an apparatus operating as an access point does not exist around the communication apparatus, the confirmation screen displays information prompting a user to select a connection method different from the first connection method.

16. The medium according to claim 1, wherein
an apparatus operating as an access point is a wireless LAN router.

17. An information processing apparatus holding an application program, comprising at least one memory and at least one processor which function as:
a first display unit configured to display, by the application program, a selection screen for selecting any connection method of connecting a communication apparatus to another apparatus;
a second display unit configured to, in a case where a selection corresponding to connecting the communication apparatus to another apparatus by a first connection method using a wireless Local Area Network (LAN) is performed on the selection screen, display, by the application program, a confirmation screen for prompting a user to confirm whether an apparatus operating as an access point exists around the communication apparatus; and
an execution unit configured to, in a case where an operation corresponding to confirming that an apparatus operating as an access point exists around the communication apparatus is performed on the confirmation screen, execute, by the application program, connection setting processing for connecting the communication apparatus to another apparatus by the first connection method, and in a case where an operation corresponding to confirming that an apparatus operating as an access point does not exist around the communication apparatus is performed on the confirmation screen, not to execute the connection setting processing by the application program.

18. A control method of an information processing apparatus holding an application program, comprising:
displaying, by the application program, a selection screen for selecting any connection method of connecting a communication apparatus to another apparatus;
displaying, in a case where a selection corresponding to connecting the communication apparatus to another apparatus by a first connection method using a wireless Local Area Network (LAN) is performed on the selection screen, a confirmation screen, by the application program, for prompting a user to confirm whether an apparatus operating as an access point exists around the communication apparatus; and
executing, by the application program, connection setting processing for connecting the communication apparatus to another apparatus by the first connection method in a case where an operation corresponding to confirming that an apparatus operating as an access point exists around the communication apparatus is performed on the confirmation screen, and not executing, by the application program, the connection setting processing in a case where an operation corresponding to confirming that an apparatus operating as an access point does not exist around the communication apparatus is performed on the confirmation screen.

19. A non-transitory computer-readable storage medium storing an application program configured to cause a computer of an information processing apparatus to function as:
a first display unit configured to display a selection screen for selecting any connection method of connecting a communication apparatus to another apparatus;
a determination unit configured to, in a case where a selection corresponding to connecting the communication apparatus to another apparatus by a first connection method using a wireless Local Area Network (LAN) is performed on the selection screen, determine whether an apparatus operating as an access point exists around the communication apparatus based on information concerning a network connected to the information processing apparatus; and
an execution unit configured to execute connection setting processing for connecting the communication apparatus to another apparatus by the first connection method in a case where it is determined that an apparatus operating as an access point exists around the communication apparatus, and not to execute the connection setting processing in a case where it is determined that an apparatus operating as an access point does not exist around the communication apparatus.

20. An information processing apparatus holding an application program, comprising at least one memory and at least one processor which function as:
a first display unit configured to display a selection screen for selecting any connection method of connecting a communication apparatus to another apparatus;
a determination unit configured to, in a case where a selection corresponding to connecting the communication apparatus to another apparatus by a first connection method using a wireless Local Area Network (LAN) is performed on the selection screen, determine whether an apparatus operating as an access point exists around the communication apparatus based on information concerning a network connected to the information processing apparatus; and
an execution unit configured to execute connection setting processing for connecting the communication apparatus to another apparatus by the first connection method in a case where it is determined that an apparatus operating as an access point exists around the communication apparatus, and not to execute the connection setting processing in a case where it is determined that an apparatus operating as an access point does not exist around the communication apparatus.

21. A control method of an information processing apparatus holding an application program, comprising:
displaying a selection screen for selecting any connection method of connecting a communication apparatus to another apparatus;
determining, in a case where a selection corresponding to connecting the communication apparatus to another apparatus by a first connection method using a wireless Local Area Network (LAN) is performed on the selection screen, whether an apparatus operating as an access point exists around the communication apparatus based on information concerning a network connected to the information processing apparatus; and
executing connection setting processing for connecting the communication apparatus to another apparatus by the first connection method in a case where it is determined that an apparatus operating as an access point exists around the communication apparatus, and not executing the connection setting processing in a case where it is determined that an apparatus operating as an access point does not exist around the communication apparatus.
